(19) United States
(12) Patent Application Publication
(10) Pub. No.: US 2026/0189041 A1
(43) Pub. Date: Jul. 2, 2026

(54) BATTERY PACK CHARGER

(71) Applicant: Black & Decker Inc., New Britain, CT (US)

(72) Inventors: John Kenrick H. Fuerte, Bel Air, MD (US); Bradley Vanscoyk, Honey Brook, PA (US); Michael Gregory Cox, Felton, PA (US); Neal Hassel, Parkville, MD (US); Brian K. Wohltmann, Shrewsbury, PA (US); Michael E. Cruz, Milford, PA (US); Cole Macri, Forest Hill, MD (US); Weston P. Harris, Baltimore, MD (US)

(21) Appl. No.: 19/539,644

(22) Filed: Feb. 13, 2026

Related U.S. Application Data
(63) Continuation of application No. PCT/US2024/042979, filed on Aug. 19, 2024.
(60) Provisional application No. 63/520,315, filed on Aug. 17, 2023.
(60) Provisional application No. 63/584,755, filed on Sep. 22, 2023.
(60) Provisional application No. 63/520,316, filed on Oct. 24, 2023.
(60) Provisional application No. 63/520,317, filed on Oct. 24, 2023.
(60) Provisional application No. 63/622,460, filed on Jan. 18, 2024.

(51) Int. Cl. H02J 7/70

(52) U.S. Cl. CPC H02J 7/751

(57) ABSTRACT

A battery pack charger comprises a housing. The housing includes a first side and a second side, opposed to the first side. The first side includes a first interface configured to receive a battery pack along a first axis. The second side includes a second interface configured to mount to a storage container. The second interface includes a coupling plate for coupling the housing to the storage container. The coupling plate is configured to be attachable to the second side of the housing in a first orientation. In a second orientation, the coupling plate second orientation is rotated 180° about a second axis generally perpendicular to the first axis from the coupling plate first orientation

### CROSS-REFERENCE TO RELATED APPLICATION(S)

This application is a continuation of Patent Cooperation Treaty Application No. PCT/US2024/042979, filed on Aug. 19, 2024, entitled “Battery Pack Charger”, and claims the benefit of priority thereof under 35 U.S.C. § 120, and which claims the benefit of priority to each of: U.S. Provisional Patent Application Ser. No. 63/520,315, filed Aug. 17, 2023, titled “Battery Pack”; U.S. Provisional Patent Application Ser. No. 63/520,316 filed Aug. 17, 2023, titled “Battery Pack Charger”; U.S. Provisional Patent Application Ser. No. 63/520,317 filed Aug. 17, 2023, titled “Battery Pack Adaptor”; U.S. Provisional Patent Application Ser. No. 63/584,755 filed Sep. 22, 2023, titled “Battery Pack Interface”; and U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”.

### INCORPORATION BY REFERENCE

Patent Cooperation Treaty Application No. PCT/US2024/042979, filed on Aug. 19, 2024, entitled “Battery Pack Charger”, is incorporated herein in its entirety by reference.

U.S. Provisional Patent Application Ser. No. 63/520,315, filed Aug. 17, 2023, titled “Battery Pack”, is incorporated herein in its entirety by reference.

U.S. Provisional Patent Application Ser. No. 63/520,316, filed Aug. 17, 2023, titled “Battery Pack Charger”, is incorporated herein in its entirety by reference.

U.S. Provisional Patent Application Ser. No. 63/520,317, filed Aug. 17, 2023, titled “Battery Pack Adaptor”, is incorporated herein in its entirety by reference.

U.S. Provisional Patent Application Ser. No. 63/584,755 filed Sep. 22, 2023, titled “Battery Pack Interface”, is incorporated herein in its entirety by reference.

U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”, is incorporated herein in its entirety by reference.

This application is related to U.S. patent application Ser. No. 18/114,121, filed on Feb. 24, 2023, titled “Cordless Power Tool System”, which in turn claims the benefit of priority from U.S. Provisional Patent Application Ser. No. 63/268,451, filed on Feb. 24, 2022, titled “Cordless Power Tool System”, the contents all of which are incorporated herein in their entireties by reference.

This application also is related to Patent Cooperation Treaty Application No. PCT/US2024/042983, filed on Aug. 19, 2024, titled “Battery Packs, Battery Pack Chargers, Battery Pack Interfaces and Adaptors of a Cordless Power Tool System”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042984, filed on Aug. 19, 2024, titled “Battery Pack”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042976, filed on Aug. 19, 2024, titled “Battery Pack-Power Tool Interface”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042973, filed on Aug. 19, 2024, titled “Battery Pack Adaptor”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US2024/042820, filed on Aug. 16, 2024, titled “Cordless Power Tool System”, which in turn claims the benefit of priority from U.S. Provisional Patent Application Ser. No. 63/622,475, filed Jan. 18, 2024, the contents all of which are incorporated herein in their entireties by reference.

### FIELD

The patent application relates to a battery pack charger of a cordless power tool system.

### BACKGROUND

Removable, rechargeable battery packs are becoming ubiquitous as more and more devices become cordless to take advantage of the advances in battery technology. Such battery packs are commonly part of cordless power tool systems and are designed and configured to operate with a variety of cordless power tools.

Conventional rechargeable battery packs may include Li-Ion battery cells. Due to the nature of the chemistry of these battery packs, the United States and many other countries and international bodies, including the United Nations, have implemented special rules directed to the shipping of Li-Ion batteries. If a battery or battery pack exceeds these rules/limits, there are additional fees and shipping costs for shipping the battery pack. As such, there is an interest in keeping the Watt-hour levels below the 100 Wh limits. Today, it is common for Li-Ion batteries to exceed these limits. As battery power and capacity increases it will become more common for batteries to exceed these limits. As such, there is a great desire to keep address this issue.

Typically, shipping regulations impose limitations upon how much energy is disposed in a battery pack. For example, some regulations require that each cell have an energy equal to or less than 20 Watt-hours, and that each battery pack has an energy limit equal to or less than 100 Watt-hours. It is preferable to provide a solution that can maximize the energy available to the end user while complying with shipping regulations. Preferably, a switching system could be used to separate components of the battery pack, thus opening the battery pack circuit, limiting the energy output.

While, for ground service (highway and rail), United States Department of Transportation (USDOT) regulations allow for certain packaging and shipment exceptions for batteries below 300 watt-hours, USDOT regulations for batteries above 300 watt-hours require special packaging (e.g., “Class 9” packaging) around the battery packs for shipment to be permissible.

The present patent application describes an example battery pack for use with a power tool system utilizing pouch battery cells and an example method of manufacturing such a battery pack.

Typically, rechargeable battery packs are charged using battery pack chargers that are designed and configured to charge specific battery packs. These chargers are designed and configured to plug into a wall outlet for access to alternating current (AC) mains line (utility) power or some other source of AC power, such as a generator. The battery packs, the power tools, and the chargers generally include an interface system that enables the battery pack to couple to the power tool and the charger, as is well known in the art. Various interfaces are known for electrically and physically coupling the battery pack with an electrical apparatus such as a power tool or a battery pack charge.

While prior art power tool systems including a set of cordless power tools, a set of releasably attachable battery packs and a set of battery pack chargers all designed and configured to operate with each other by an original equipment manufacturer have proven to be more than suitable for their intended purposes, each battery pack in the set of battery packs is limited for use with an associated tool of the set of cordless power tools and an associated charger of the set of battery pack chargers. Thus, it remains desirable in the art to provide an adaptor for a first battery pack having a first configuration specifically designed and configured to operate with a first type of power tool system that enables use of the first battery pack as a substitute for a second battery pack having a second configuration specifically designed and configured to operate with a second type of power tool system. Further, the cordless power tools and the battery packs may be used in heavy contamination environments. This type of environment may expose the cordless power tools and the battery packs to water and particulate ingress that may reduce the performance and warranty life expectancy. The present patent application provides improvements in the battery pack adaptors.

### SUMMARY

One aspect of the present patent application provides a battery pack charger. The battery pack charger comprises a housing. The housing includes a first side and a second side, opposed to the first side. The first side includes a first interface configured to receive a battery pack along a first axis. The second side includes a second interface configured to mount to a storage container. The second interface includes a coupling plate for coupling the housing to the storage container. The coupling plate is configured to be attachable to the second side of the housing in a first orientation. In a second orientation, the coupling plate second orientation is rotated 180° about a second axis generally perpendicular to the first axis from the coupling plate first orientation.

Implementations of the foregoing aspects may include one or more of the following features.

In an aspect of the present patent application, the first side may include a top of the battery pack charger. The second side may include a bottom of the battery pack charger. The first axis may include a horizontal insertion direction of the battery pack.

In an aspect of the present patent application, the first interface of the battery pack charger may be configured to facilitate interconnections with the battery pack. The first interface may include a set of terminals configured for engagement along the first axis to the battery pack and may be configured to provide an electrical interconnection with the battery pack. The first interface may include a rail interface portion configured for engagement along the first axis to the battery pack and configured to provide a physical interconnection with the battery pack.

In an aspect of the present patent application, the storage container may include a pair of first connection elements and a pair of second connection elements. The pair of first connection elements and the pair of second connection elements may be disposed on a top portion of the storage container. The pair of first connection elements may be disposed at end portions of the storage container. The pair of second connection elements may be disposed between the pair of first connection elements of the storage container.

In an aspect of the present patent application, the coupling plate may include a top, a bottom, a first side and a second side, opposed to the first side. The coupling plate may include a first connection element disposed on the first side of the coupling plate. The coupling plate may include a second connection element disposed on the second side of the coupling plate.

In an aspect of the present patent application, the first connection element of the coupling plate may be configured to mate with one of the pair of first connection elements of the storage container when the coupling plate is in the first orientation. The first connection element of the coupling plate may be configured to mate with the other of the pair of first connection elements of the storage container when the coupling plate is in the second orientation.

In an aspect of the present patent application, the second connection element of the coupling plate may be configured to mate with one of the pair of second connection elements of the storage container when the coupling plate is in the first orientation. The second connection element of the coupling plate may be configured to mate with the other of the pair of second connection elements of the storage container when the coupling plate in the second orientation.

In an aspect of the present patent application, the housing may include a third side and a fourth side, opposed to the third side. The top of the coupling plate may be configured to be removably connected to the battery pack charger on the second side of the battery pack charger. The first side of the coupling plate may be configured to be disposed on the third side of the battery pack charger. The second side of the coupling plate may be configured to be disposed on the fourth side of the battery pack charger, when the coupling plate is in the first orientation. The first side of the coupling plate may be configured to be disposed on the fourth side of the battery pack charger. The second side of the coupling plate may be configured to be disposed on the third side of the battery pack charger, when the coupling plate is attached in the second orientation.

In an aspect of the present patent application, the first connection element of the coupling plate may have a different configuration than the second connection element of the coupling plate.

In an aspect of the present patent application, the first connection element of the coupling plate may be configured to engage and mate with each of the pair of first connection elements of the storage container.

In an aspect of the present patent application, the second connection element of the coupling plate may be configured to engage and mate with each of the pair of second connection elements of the storage container.

Another aspect of the present patent application provides a battery pack charger system. The battery pack charger system comprises a battery pack charger, and a storage system comprising a plurality of storage containers and an attachment system. The attachment system includes a first set of components incorporated into a first storage container of the plurality of storage containers and a second set of components incorporated into a second storage container of the plurality of storage containers. The first set of components of the first storage container is configured to mate with the second set of components of the second storage container to affix the first storage container to the second storage container. The battery pack charger system comprises a coupling plate including a third set of components configured to mate with (a) a first subset of the first set of components of the first storage container for affixing the charger to the first storage container at a first location and (b) a second subset of the first set of components of the first storage container for affixing the charger to the first storage container at a second location. The second location is adjacent to the first location.

Implementations of the foregoing aspects may include one or more of the following features.

In an aspect of the present patent application, the first storage container may include a wheeled storage container.

In an aspect of the present patent application, the second storage container may include a non-wheeled storage container.

In an aspect of the present patent application, the first set of components of the first storage container may include a pair of first connection elements and a pair of second connection elements. The pair of first connection elements and the pair of second connection elements may be disposed on a top portion of the first storage container. The pair of first connection elements may be disposed at end portions of the first storage container. The pair of second connection elements may be disposed between the pair of first connection elements of the first storage container. The first subset of the first set of components of the first storage container may include one of the pair of first connection elements of the first storage container and one of the pair of second connection elements of the first storage container. The second subset of the first set of components of the first storage container may include the other of the pair of first connection elements of the first storage container and the other of the pair of second connection elements of the first storage container.

In an aspect of the present patent application, the second set of components of the second storage container may include a pair of first connection elements. The pair of first connection elements of the second storage container may be disposed on a bottom portion of the second storage container. The pair of first connection elements of the first storage container may be configured to engage and mate with the pair of first connection elements of the second storage container to affix the first storage container to the second storage container.

In an aspect of the present patent application, the coupling plate may include a top, a bottom, a first side and a second side, opposed to the first side. The third set of components of the coupling plate may include a first connection element disposed on the first side of the coupling plate and a second connection element disposed on the second side of the coupling plate.

In an aspect of the present patent application, the first connection element of the coupling plate may be configured to mate with one of the pair of first connection elements of the first storage container when the battery pack charger is affixed to the first storage container at the first location. The first connection element of the coupling plate may be configured to mate with the other of the pair of first connection elements of the first storage container when the battery pack charger is affixed to the first storage container at the second location.

In an aspect of the present patent application, the second connection element of the coupling plate may be configured to mate with one of the pair of second connection elements of the first storage container when the battery pack charger is affixed to the first storage container at the first location. The second connection element of the coupling plate may be configured to mate with the other of the pair of second connection elements of the first storage container when the battery pack charger is affixed to the first storage container at the first location.

In an aspect of the present patent application, the battery pack charger may be a first battery pack charger and the coupling plate may be a first coupling plate. The battery pack charger system may further include a second battery pack charger and a second coupling plate. The first connection element of the first coupling plate may be configured to mate with one of the pair of first connection elements of the first storage container and the second connection element of the first coupling plate may be configured to mate with one of the pair of second connection elements of the first storage container when the first battery pack charger is affixed to the first storage container at the first location. A first connection element of the second coupling plate may be configured to mate with the other of the pair of first connection elements of the first storage container and a second connection element of the second coupling plate may be configured to mate with the other of the pair of second connection elements of the first storage container when the second battery pack charger is affixed to the first storage container at the second location.

In an aspect of the present patent application, the first coupling plate and the second coupling plate may be configured to be interchangeable with each other such that (1) the first coupling plate is configured to be used with either the first battery pack charger or the second battery pack charger to affix the first battery pack charger or second battery pack charger to the first storage container either at the first location or at the second location, and (2) the second coupling plate is configured to be used with either the first battery pack charger or the second battery pack charger to affix the first battery pack charger or the second battery pack charger to the first storage container either at the first location or at the second location.

Another aspect of the present patent application provides a battery pack charger comprising a housing and a roll cage affixed to the housing. The roll cage includes at least one handle to enable carrying the battery pack charger with a battery pack insertion direction being vertical and at least one handle to enable carrying the battery pack charger with the battery pack insertion direction being horizontal.

Implementations of the foregoing aspects may include one or more of the following features.

In an aspect of the present patent application, when the battery pack charger is disposed such that the battery pack insertion direction is horizontal, the housing of the battery pack charger includes a top, a bottom, a front, a back, and a pair of opposing sides. The at least one handle to enable carrying the battery pack charger with the battery pack insertion direction being vertical includes a first handle attached to the front of the housing.

In an aspect of the present patent application, the first handle may be configured to extend outwardly from a front wall of the battery pack charger, when the battery pack charger is disposed such that the battery pack insertion direction is horizontal.

In an aspect of the present patent application, the roll cage may include a roll cage frame defined by substantially tubular members. The roll cage frame may include a pair of opposing side frame portions that are spaced from and substantially parallel to each other. The roll cage frame may also include a rear frame portion that is disposed in a plane that is perpendicular to planes of the pair of opposing side frame portions.

In an aspect of the present patent application, the at least one handle to enable carrying the battery pack charger with the battery pack insertion direction being horizontal may include a pair of side handles attached to the pair of opposing sides of the housing.

Another aspect of the present patent application provides a battery pack charger comprises a housing and a roll cage affixed to the housing. The roll cage provides stable support for a first orientation in which the battery pack insertion direction is generally horizontal. The roll cage provides stable support for a second orientation in which the battery pack insertion direction is generally vertical.

Implementations of the foregoing aspects may include one or more of the following features.

In an aspect of the present patent application, the roll cage may include a roll cage frame defined by substantially tubular members. The roll cage frame may include a pair of opposing side frame portions that are spaced from and substantially parallel to each other. The roll cage frame may also include a rear frame portion that is disposed in a plane that is perpendicular to planes of the pair of opposing side frame portions.

In an aspect of the present patent application, the pair of opposing side frame portions of the roll cage may be configured to provide stable support for the first orientation in which the battery pack insertion direction is horizontal.

In an aspect of the present patent application, the rear frame portion of the roll cage may be configured to provide stable support for the second orientation in which the battery pack insertion direction is generally vertical.

In an aspect of the present patent application, the battery pack charger may include a coupling plate for coupling the housing to a storage container. A bottom of the housing of the battery pack charger may be configured to removably attached to a top of the coupling plate. The bottom of the coupling plate may be configured to provide stable support for the first orientation in which the battery pack insertion direction is generally horizontal.

Another aspect of the present patent application provides a battery pack charger comprising a housing, a set of inlet vents on the first side of the housing, a set of outlet vents on the second side of the housing, a first baffle within the housing defining a first airflow pathway, and a second baffle within the housing defining a second airflow pathway. The housing includes a first side and a second side opposed the first side. The first baffle and the second baffle define a third airflow pathway. The battery pack charger comprises a plurality of power supply charging components centrally positioned within the housing along the third airflow pathway, and a fan within the housing. The fan draws air into the housing through the set of inlet vents along the first airflow pathway, along the third airflow pathway past the plurality of power supply charging components, through the fan, along the second airflow pathway and forcing the air out of the housing through the set of outlet vents.

Implementations of the foregoing aspects may include one or more of the following features.

In an aspect of the present patent application, the first airflow pathway, the second airflow pathway, and the third airflow pathway may form an S-shaped airflow pathway

In an aspect of the present patent application, the housing may include a first housing portion and a second housing portion. The battery pack charger may further comprise an electronics module subassembly disposed on the second housing portion.

In an aspect of the present patent application, the first housing portion may be an upper housing portion and the second housing portion may be a lower housing portion.

In an aspect of the present patent application, the fan may be positioned upstream of the first airflow pathway and the third airflow pathway. The second airflow pathway may be disposed downstream of the fan.

In an aspect of the present patent application, the second airflow pathway may be disposed downstream of the fan. The set of inlet vents may be configured to permit air from an ambient environment to enter the housing as intake air.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present patent application will become apparent from the following detailed description, the accompanying drawings, and the appended claims.

Each of the aspects described above and in the following description can be used in any combination of one or more of these aspects, as will be understood to one of ordinary skill in the art.

### BRIEF DESCRIPTION OF THE DRAWINGS

FIGS. 1 and 2 show an example power tool system in accordance with an embodiment of the present patent application;

FIG. 3 shows a front end view of a battery pack charger in accordance with an embodiment of the present patent application;

FIG. 4 shows a right side view of the battery pack charger;

FIG. 5 shows a rear end view of the battery pack charger;

FIG. 6 shows a left side view of the battery pack charger;

FIG. 7 shows a top plan view of the battery pack charger;

FIG. 8 shows a bottom plan view of the battery pack charger;

FIGS. 9-16 show various perspective views of the battery pack charger;

FIGS. 17A-17B show perspective views of the battery pack charger and a roll cage, wherein the roll cage is shown separate from the battery pack charger and before the roll cage is attached to the battery pack charger;

FIG. 18 shows a front end view of the battery pack charger with the roll cage attached thereto;

FIG. 19 shows a right side view of the battery pack charger with the roll cage attached thereto;

FIG. 20 shows a rear end view of the battery pack charger with the roll cage attached thereto;

FIG. 21 shows a left side view of the battery pack charger with the roll cage attached thereto;

FIG. 22 shows a top plan view of the battery pack charger with the roll cage attached thereto;

FIG. 23 shows a bottom plan view of the battery pack charger with the roll cage attached thereto;

FIGS. 24-31 show various perspective views of the battery pack charger with the roll cage attached thereto;

FIG. 32 shows a rear end view of a battery pack;

FIG. 33 shows a right side view of the battery pack;

FIGS. 34-38 show various perspective views of the battery pack;

FIG. 39 shows a right side view of the battery pack connected to the battery pack charger with the roll cage attached to the battery charger;

FIG. 40 shows a rear end view of the battery pack connected to the battery pack charger with the roll cage;

FIG. 41A shows a left side view of the battery pack connected to the battery pack charger with the roll cage, wherein the housing of the battery pack charger provides support for a first orientation (e.g., horizontal) in which the battery pack insertion direction is generally horizontal;

FIG. 41B shows a left side view of the battery pack connected to the battery pack charger with the roll cage, wherein the roll cage provides stable support for a second orientation (e.g., vertical) in which the battery pack insertion direction is generally vertical;

FIG. 42 shows a front end view of the battery pack connected to the battery pack charger with the roll cage;

FIG. 43 shows a top plan view of the battery pack connected to the battery pack charger with the roll cage;

FIG. 44 shows a bottom plan view of the battery pack connected to the battery pack charger with the roll cage;

FIGS. 45-46 show perspective views of the battery pack connected to the battery pack charger with the roll cage;

FIG. 47 shows a top plan view of an exemplary coupling plate for coupling the battery pack charger to a storage container;

FIGS. 48A-48B show a top perspective view of the coupling plate and a detailed (top perspective) view of a first connection element of the coupling plate;

FIGS. 49A-49B show a top perspective view of the coupling plate and a detailed (top perspective) view of a second connection element of the coupling plate;

FIG. 50 shows a bottom perspective view of the coupling plate;

FIG. 51 shows a bottom plan view of the coupling plate;

FIG. 52 shows a left side view of the battery pack charger with the roll cage and the coupling plate before the coupling plate is attached to the battery pack charger;

FIGS. 53A-53B show a front, bottom, left-side isometric view and a front, top, right-side isometric view, respectively, of the battery pack charger with the roll cage and the coupling plate before the coupling plate is attached to the battery pack charger/roll cage assembly, the coupling plate in a first orientation;

FIGS. 54A-54B show a front, top, right-side isometric view and a front, bottom, left-side isometric view, respectively, of the battery pack charger with the roll cage and the coupling plate before the coupling plate is attached to the battery pack charger/roll cage assembly, the coupling plate in a second orientation;

FIGS. 55A-55D show a front elevational view, a rear elevational view, a right side elevational view, and a left, side elevational view, respectively, of the battery pack charger with the roll cage and the coupling plate after the coupling plate is attached to the battery pack charger/roll cage assembly, the coupling plate in the first orientation;

FIG. 55E shows a bottom, plan view of the battery pack charger with the roll cage and the coupling plate after the coupling plate is attached to the battery pack charger/roll cage assembly, the coupling plate in the first orientation;

FIG. 55F shows a perspective view of the battery pack charger with the roll cage and the coupling plate after the coupling plate is attached to the battery pack charger/roll cage assembly, the coupling plate in the first orientation;

FIGS. 55G-55I show perspective views of the battery pack charger with the roll cage and the coupling plate after they are connected to each other, wherein the battery pack insertion direction is along a vertical axis;

FIG. 56 shows a front, top, left-side isometric view of a first storage container of a storage system;

FIG. 57 shows a front, top, left-side isometric view of a second storage container of the storage system;

FIGS. 58A-58B show a left side elevation view and a front, top, right side isometric view, respectively, of the storage system;

FIG. 59 shows a left side isometric view of the storage system;

FIG. 60 shows a front, top, right side perspective view of the storage system and the battery pack charger with the roll cage and the coupling plate before the coupling plate is attached to the first storage container of the storage system;

FIGS. 61A-61C shows a front, top, right side perspective view, a front view and a front, top, left side perspective view, respectively, of the storage system and the battery pack charger after the coupling plate is attached to the first storage container of the storage system, wherein the battery pack charger is disposed in a first location, wherein the roll cage and the coupling plate are connected to the battery pack charger;

FIGS. 62A-62B shows a front elevation view and a front, top right side perspective view, respectively, of the storage system, the battery pack and the battery pack charger after the coupling plate is attached to the first storage container of the storage system, wherein the battery pack charger is disposed in the first location, wherein the roll cage, the battery pack and the coupling plate are connected to the battery pack charger;

FIG. 63 shows a perspective view of the storage system and two battery pack chargers before their coupling plates are attached to the first storage container of the storage system;

FIG. 64 shows a front, top, right side isometric view of the storage system and two battery pack chargers after the coupling plate of one of the battery pack chargers is attached to the first storage container of the storage system at the first location and before the coupling plate of the other of the battery pack charger is attached to the first storage container of the storage system at a second location;

FIGS. 65A-65C show a front elevational view, a top, front, right side view and a top, front, left side view, respectively, of the storage system and two battery pack chargers after the coupling plates of the two battery pack chargers are attached to the first storage container of the storage system at the first and second locations, wherein the coupling plate of the first battery pack charger is in a first orientation and the coupling plate of the second battery pack charger is in a second orientation;

FIG. 66 shows a perspective view of the storage system and two battery pack chargers after the battery pack chargers are attached to the first storage container of the storage system at the first and second locations, wherein one battery pack is connected to the first battery pack charger;

FIG. 67 shows a perspective view of the storage system and two battery pack chargers after the battery pack chargers are attached to the first storage container of the storage system at the first and second locations, wherein a battery pack is connected to each of the two battery pack chargers;

FIGS. 68A-68D show bottom perspective views of the battery pack charger with the roll cage and the coupling plate, wherein FIG. 68A shows the coupling plate attached to the battery pack charger in a first orientation, FIG. 68B shows the coupling plate removed/detached from the battery pack charger and aligned with the battery pack charger in the first orientation, FIG. 68C shows the coupling plate removed/detached from the battery pack charger and aligned with the battery pack charger in a second orientation, and FIG. 68D shows the coupling plate is attached to the battery pack charger in the second orientation;

FIGS. 69A-69F show a left side view, four perspective views, and a top plan view of the battery pack charger with the roll cage and the coupling plate and the battery pack in a first orientation such that a battery pack insertion direction is along a generally horizontal axis;

FIGS. 69G-69I show various perspective views of the battery pack charger with the roll cage and the coupling plate and the battery pack disposed in a second orientation such that a battery pack insertion direction is along a generally vertical axis;

FIG. 70 shows an example method for operation of the battery pack charger in accordance with an embodiment of the present patent application;

FIG. 71 shows an example circuit diagram of the battery pack charger in accordance with an embodiment of the present patent application;

FIGS. 72-75 show a cooling system of the battery pack charger in accordance with an embodiment of the present patent application; and

FIG. 76 shows an example user interface or a display.

### DETAILED DESCRIPTION

Additional details of embodiments of various battery packs and power tools considered within the scope of the present disclosure can be found in at least U.S. Provisional Patent Application Nos. 62/636,395, 62/853,694, 62/636,568, 63/359,940, 63/533,751, 63/533,754, 63/533,755, 63/533,758, 63/578,008; U.S. patent application Ser. No. 18/114,121; U.S. Pat. No. 9,406,915; European Patent Application Nos. EP22202110.7, EP22194105.7, EP23163288.6, and EP23192793.0; PCT Patent Application Nos. PCT/EP2022/074710, PCT/EP2023/072939, PCT/EP2023/072638, and PCT/EP2023/072679; and U.K. Patent Application Nos. GB2112789.9, GB2209009.6, and GB2218350.3. The disclosures of each of the above applications and patents are hereby incorporated by reference in their entirety.

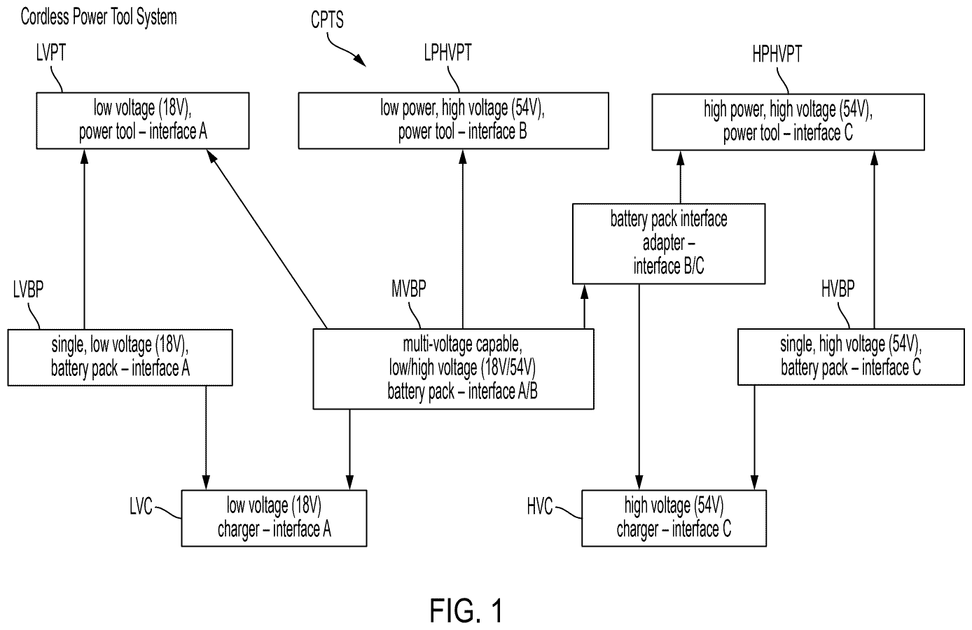

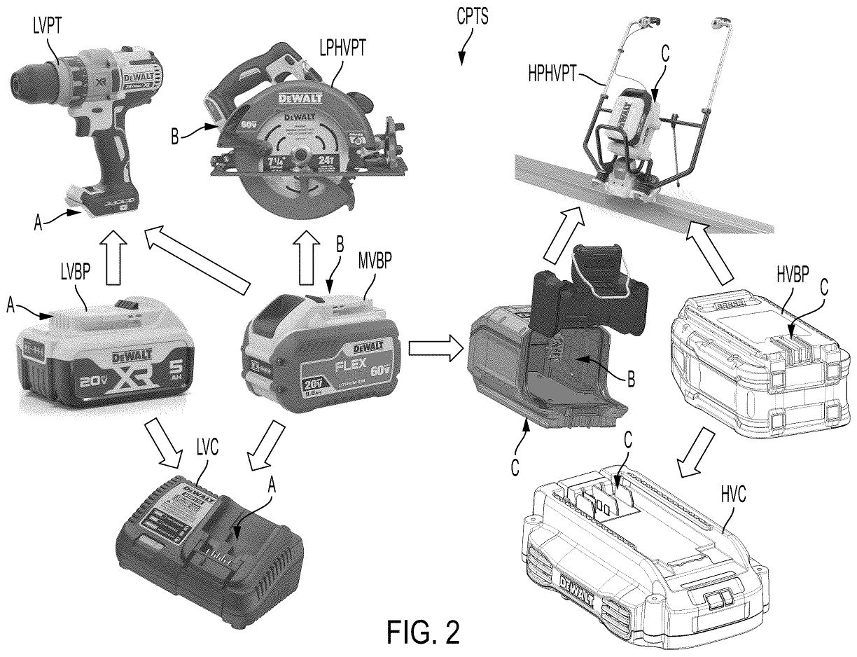

Referring to FIGS. 1-2, the present patent application provides a cordless power tool system (CPTS). The CPTS may include a first power tool, a second power tool, a third power tool, a first battery pack, second battery pack. The first power tool may include a high power, high voltage power tool (HPHVPT). The HPHVPT may have a first power tool rated voltage (e.g., 54 volts (V)). The HPHVPT may have a first power tool interface (e.g., interface C). The second power tool may include a low power, high voltage power tool (LPHVPT). The LPHVPT may have second power tool rated voltage (e.g., 54V). The LPHVPT may have a second power tool interface (e.g., interface B) that is different from the first power tool interface (e.g., interface C). The third power tool may include a low voltage power tool (LVPT). The LVPT may have a third power tool rated voltage (e.g., 18V). The LVPT may have a third power tool interface (e.g., interface A) that is different from the first power tool interface (e.g., the interface C) and the second power tool interface (e.g., the interface B).

Referring to FIGS. 1-2, in one example embodiment, the CPTS may include a high voltage battery pack (HVBP) and a set of cordless HPHVPT (one shown). The CPTS also may include a high voltage charger (HVC) 5000. Each of the cordless power tools of the set of cordless power tools may be powered by the HVBP. The set of power tools may include, for example, a screed, a concrete plate compactor, a rammer, a concrete vibrator powerpack, a concrete vibrator backpack, and a concrete/core drill. It is understood that the HPHVPT illustrated in FIGS. 1-2 are examples and that other power devices are contemplated to be included as part of the CPTS, even though not illustrated. In one example implementation, the HPHVPT have an operating voltage of 54V. Each HPHVPT may include a receptacle for receiving the HVBP. The power tool receptacle may include an interface for mating with the HVBP. The battery pack receptacle may be configured with one interface for receiving one removable, rechargeable battery pack, for example, the HVBP.

The first battery pack may be a single (fixed), high voltage battery pack (HVBP). The HVBP may have a first nominal voltage (e.g., 54V) that is substantially the same as the first power tool rated voltage (e.g., 54V). The HVBP may have the first battery pack interface (e.g., the interface C) that is connectable to the first power tool interface (i.e., the interface C) to provide power to the HPHVPT. The first battery pack interface (e.g., the interface C) of the HVBP is not connectable to the second power tool interface (e.g., the interface B) or the third power tool interface (e.g., the interface A).

The second battery pack may be a multi-voltage capable (low voltage/high voltage) battery pack MVBP. The MVBP may have a second battery pack interface (e.g., the interface A/B) that is coupleable to the second power tool interface (e.g., the interface B) of the LPHVPT and that is coupleable to the third power tool interface (i.e., the interface A) of the LVPT.

The MVBP may have the first nominal voltage (e.g., 54V) that is substantially the same as the first power tool rated voltage (e.g., 54V) when the MVBP is coupled to the HPHVPT or connected to the LPHVPT and may have a second nominal voltage (e.g., 18V) that is substantially the same as the third power tool rated voltage (e.g., 18V) when the MVBP is connected to the LVPT. The MVBP may be configured to be coupled to the HPHVPT to provide power to the HPHVPT (e.g., it will require the adaptor to couple the MVBP and the HPHVPT). It is noted that, in the present patent application, the battery and the power tool may be “connected” when there is no adaptor, while the battery and the power tool may be “coupled” when there is an adaptor. The MVBP pack may also be configured to be connected to the LVPT to provide power to the LVPT.

The CPTS may further comprise an adaptor having a first adaptor interface (e.g., interface C) configured to be connected to the first power tool interface (e.g., the interface C) of the HPHVPT and a second adaptor interface (e.g., interface B) configured to be connected to the second battery pack interface (e.g., the interface A/B) of the MVBP to couple the MVBP to the HPHVPT.

The second battery pack interface (e.g., the interface A/B) of the MVBP is not able to be coupled to the first power tool interface (e.g., the interface C) of the HPHVPT without the adaptor.

The rated voltage of the HPHVPT and the rated voltage of the LPHVPT are the same. The rated voltage of the HPHVPT and the rated voltage of the LPHVPT may be 54V.

The nominal voltage of the HVBP and the nominal voltage of the MVBP may be the same. The nominal voltage of the HVBP and the nominal voltage of the MVBP may be 54V.

The third battery pack may be a single (fixed) voltage (low voltage) battery pack (LVBP). The LVBP may have the second nominal voltage (e.g., 18V) that is substantially the same as the third power tool rated voltage (e.g., 18V). The LVBP may have a third battery pack interface (e.g., the interface A) that is connectable to the third power tool interface (e.g., the interface A) of the third power tool HPHVPT. The third battery pack LVBP may have a third battery pack interface (e.g., the interface A) that is not connectable to the first power tool interface (e.g., the interface C) of the HPHVPT or the second power tool interface (e.g., the interface B) of the LPHVPT.

As used in this application, rated voltage may refer to the advertised voltage or the operating voltage, depending on the context. The rated voltage may also encompass a single (fixed) voltage, several discrete voltages, or one or more ranges of voltages. As used in the application, rated voltage may refer to any of these types of voltages or a range of any of these types of voltages.

Advertised Voltage: With respect to power tools, battery packs, and chargers, the advertised voltage generally refers to a voltage that is designated on labels, packaging, user manuals, instructions, advertising, marketing, or other supporting documents for these products by a manufacturer or seller so that a user is informed which power tools, battery packs, and chargers will operate with one another. The advertised voltage may include a numeric voltage value, or another word, phrase, alphanumeric character combination, icon, or logo that indicates to the user which power tools, battery packs, and chargers will work with one another. In some embodiments, as discussed below, a power tool, battery pack, or charger may have a single advertised voltage (e.g., 20V or 60V), a range of advertised voltages (e.g., 20V-60V), or a plurality of discrete advertised voltages (e.g., 20V/60V). As discussed further below, a power tool may also be advertised or labeled with a designation that indicates that it will operate with both a DC power supply and an AC power supply (e.g., AC/DC or AC/60V). An AC power supply may also be said to have an advertised voltage, which is the voltage that is generally known in common parlance to be the AC mains voltage in a given country (e.g., 120 VAC in the United States and 220 VAC-240 VAC in Europe).

Operating Voltage: For a power tool, the operating voltage generally refers to a voltage or a range of voltages of AC and/or DC power supply(ies) with which the power tool, its motor, and its electronic components are designed to operate. For example, a power tool advertised as a 120V AC/DC tool may have an operating voltage range of 92V-132V. The power tool operating voltage may also refer to the aggregate of the operating voltages of a plurality of power supplies that are coupled to the power tool (e.g., a 120V power tool may be operable using two 60V battery packs connected in series). For a battery pack and a charger, the operating voltage refers to the DC voltage or range of DC voltages at which the battery pack or charger is designed to operate. For example, a battery pack or charger advertised as a 60V battery pack or charger may have an operating voltage range of 51V-60V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS operating voltage of 120V and an average positive operating voltage of 108V.

Nominal Voltage: For a battery pack, the nominal voltage generally refers to the average DC voltage output from the battery pack. For example, a battery pack advertised as a 60V battery pack, with an operating voltage of 51V-60V, may have a nominal voltage of 54V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS nominal voltage of 120V and an average positive nominal voltage of 108V.

Maximum Voltage: For a battery pack, the maximum voltage may refer to the fully charged voltage of the battery pack. For example, a battery pack advertised as a 60V battery pack may have a maximum fully charged voltage of 60V. For a charger, the maximum voltage may refer to the maximum voltage to which a battery pack can be recharged by the charger. For example, a 60V charger may have a maximum charging voltage of 60V.

It should also be noted that certain components of the power tools, battery packs, and chargers may themselves be said to have a voltage rating, each of which may refer to one or more of the advertised voltage, the operating voltage, the nominal voltage, or the maximum voltage. The rated voltages for each of these components may encompass a single voltage, several discrete voltages, or one or more ranges of voltages. These voltage ratings may be the same as or different from the rated voltage of power tools, battery packs and chargers. For example, a power tool motor may be said to have its own an operating voltage or range of voltages at which the motor is designed to operate. The motor rated voltage may be the same as or different from the operating voltage or voltage range of the power tool. For example, a power tool having a voltage rating of 60V-120V may have a motor that has an operating voltage of 60V-120V or a motor that has an operating voltage of 90V-100V.

The power tools, power supplies, and chargers also may have ratings for features other than voltage. For example, the power tools may have ratings for motor performance, such as an output power (e.g., maximum watts out (MWO) as described in U.S. Pat. No. 7,497,275, which is incorporated by reference herein in its entirety—“the '275 Patent”) or motor speed under a given load condition. In another example, the battery packs may have a rated capacity, which refers to the total energy stored in a battery pack. The battery pack rated capacity may depend on the rated capacity of the individual cells and the manner in which the cells are electrically connected.

This application also refers to the ratings for voltage (and other features) using relative terms such as low, medium, high, and very high. The terms low rated, medium rated, high rated, and very high rated are relative terms used to indicate relative relationships between the various ratings of the power tools, battery packs, AC power supplies, chargers, and components thereof, and are not intended to be limited to any particular numerical values or ranges. For example, it should be understood that a low rated voltage is generally lower than a medium rated voltage, which is generally lower than a high rated voltage, which is generally lower than a very high rated voltage.

Each of the power tools—LVPT, LPHVPT or HPHVPT—may include a housing. Each power tool housing may incorporate components/elements such as a motor and a working element of the power tool. Each of the power tools LVPT, LPHVPT or HPHVPT may also include a motor control circuit and a battery pack interface that are configured to enable operation from one or more DC battery pack power supplies that together have a rated voltage that corresponds to the rated voltage of the power tool. The motor may be any brushed or brushless DC electric motor, including, but not limited to, a permanent magnet brushless DC motor (BLDC), a permanent magnet DC brushed motor (PMDC), an induction motor, a universal motor, etc. The motor control circuit may include a power unit having one or more power switches (not shown) disposed between the power supply and the motor. The power switch may be an electro-mechanical on/off switch, a power semiconductor device (e.g., diode, FET, BJT, IGBT, etc.), or a combination thereof. The motor control circuit may further include a control unit or controller. The control unit may be arranged to control a switching operation of the power switches in the power unit. The motor control circuit may control the motor in fixed or variable speed. The control unit may include a micro-controller or similar programmable module configured to control gates of power switches. Additionally or alternatively, the control unit may be configured to monitor and manage the operation of the DC battery pack power supplies. Additionally or alternatively, the control unit may be configured to monitor and manage various tool operations and conditions.

The LVPT may include, but is not limited to, at least one of the following power tools: a band saws, a chop saw, a circular saw, a cutout tool, a compressor, a drill, a hammer drill, a fan, a grinder, a hammer, a dust extractor, an impact driver, an impact wrench, an inflator, a jigsaw, a joiner, a light, a magnetic drill press, a nailer, an oscillating tool, a planer, a polisher, a ratchet, a reciprocating saw, a rotary hammer, a router, a sander, a screwdriver, a screwgun, a vacuum, a blower, a chain saw, an edger, a hedge trimmer, a pressure washer, a mower, a snow thrower, a string trimmer, a tiller, or an auger. The LVPT may be configured to operate at a rated voltage of 18 V.

The LVPT may be configured to be powered by a single LVBP, which may be charged using an LVC that is designed and configured to charge the LVBP. The LVPT, the LVBP, and the LVC may have the same interface (e.g., the interface A). The interfaces may be configured for electrically and physically coupling the LVBP with the LVPT and/or the LVC.

The LPHVPT may be configured to operate at a rated voltage of 54 V. The power tool interface of the LPHVPT may be referred to as interface B in this patent application. The LPHVPT may include, but is not limited to, at least one of the following power tools: a circular saw, a drill, a grinder, a miter saw, a reciprocating saw, a rotary hammer, or a table saw.

The LPHVPT may be configured to be powered by a MVBP, which may be charged using a LVC. The LVC may be designed and configured to charge either the LVBP or the MVBP. The MVBP may be configured to power either the LVPT or the LPHVPT. The MVBP is also described in detail in U.S. Pat. No. 9,406,915, which is incorporated herein in its entirety.

The MVBP interface may incorporate two interfaces (e.g., the interface A and the interface B). The LPHVPT and the MVBP may both include the same interface (e.g., the interface B). The LVPT and the MVBP may both include the same interface (e.g., the interface A). The interface A may be configured for electrically and physically coupling the MVBP with the LVPT and/or LVC and the interface B may be configured for electrically and physically coupling the MVBP with the LPHVPT using the adaptor.

The HPHVPT may be configured to operate at a rated voltage of 54V or higher. The power tool interface of the HPHVPT may be referred to as the interface C in this patent application. The HPHVPT may include, but is not limited to, at least one of the following power tools: a jack hammer a concrete drill, a concrete saw, a 12 inch cut-off saw, a concrete vibrator, a plate/concrete plate compactor, a rammer, or a screed/concrete screed. Such HPHV power tools are also described in detail in U.S. Patent Application Publication Number 2023-0291049, which is incorporated herein in its entirety. These power tools may require a relatively high amount of power and/or runtime compared to the LPHVPT. The HPHVPT may also include, but is not limited to, a concrete mixer, a jobsite lift, a block saw, a concrete finisher, an early entry saw, and a jobsite buggy, they may be referred to as very high power tools. These power tools may have the relatively high operating voltage. These power tools may require a relatively high amount of power and/or runtime compared to the LPHVPT.

The HPHVPT may be configured to be powered by a HVBP, which may be charged using a HVC that is designed and configured to charge the HVBP. The HPHVPT, the HVBP, and the HVC may have the same interface (e.g., the interface C). The interfaces may be configured for electrically and physically connecting the HVBP with the HPHVPT and/or the HVC.

However, it will be understood by those skilled in the art that the teachings of the present patent application are not so limited.

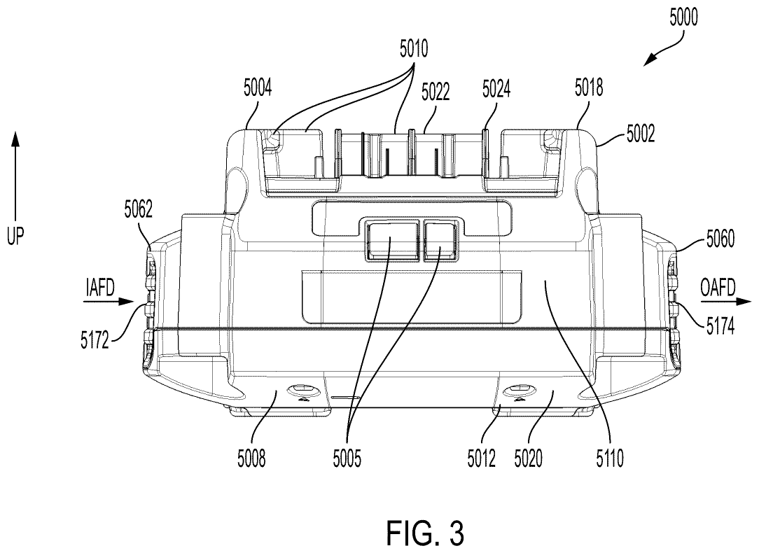

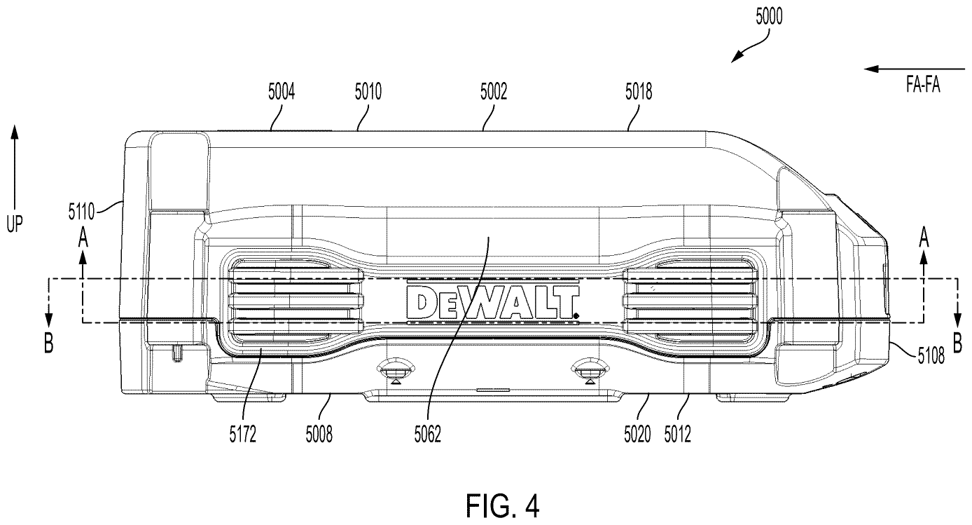

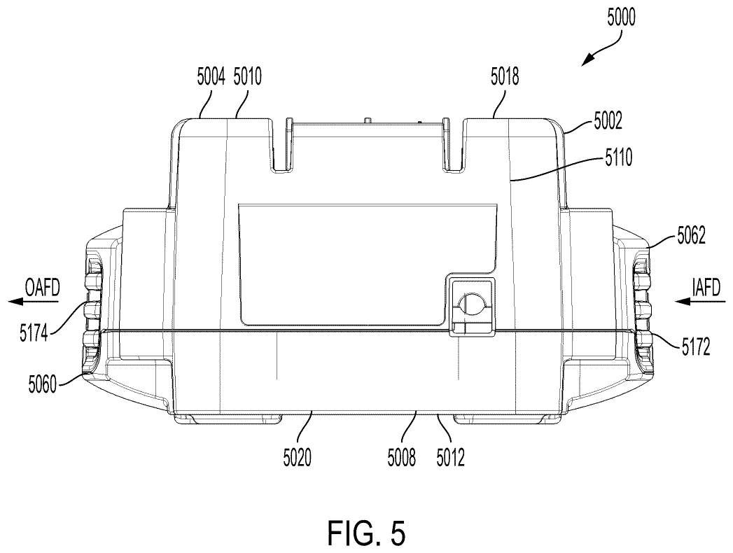

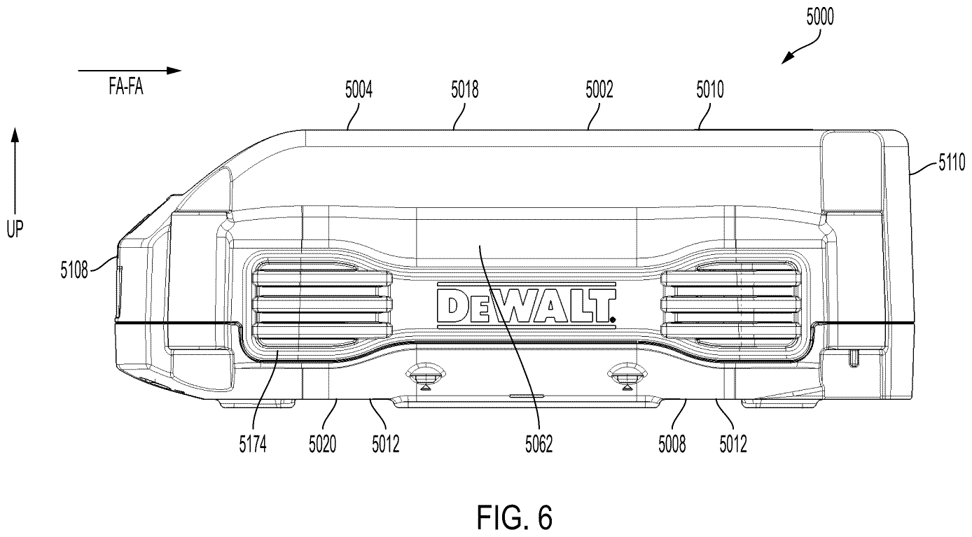

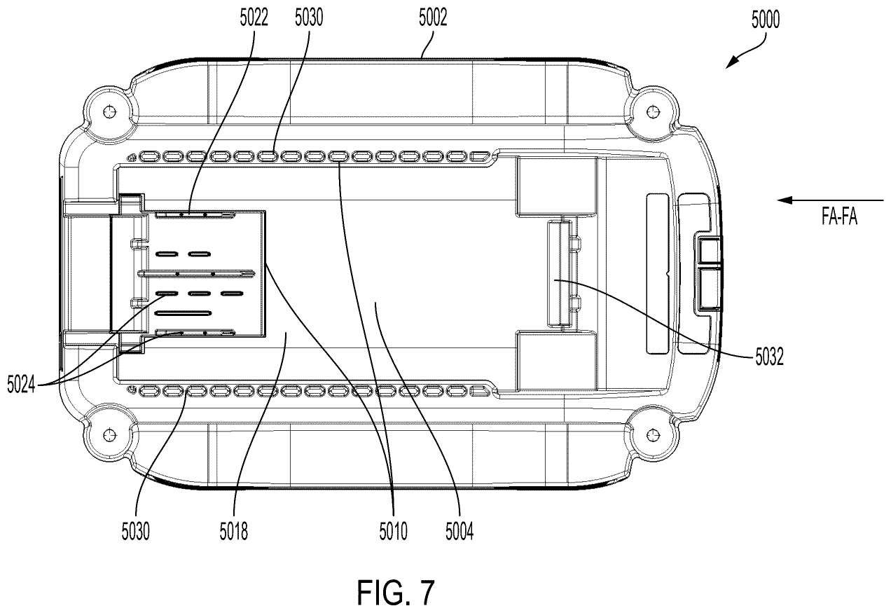

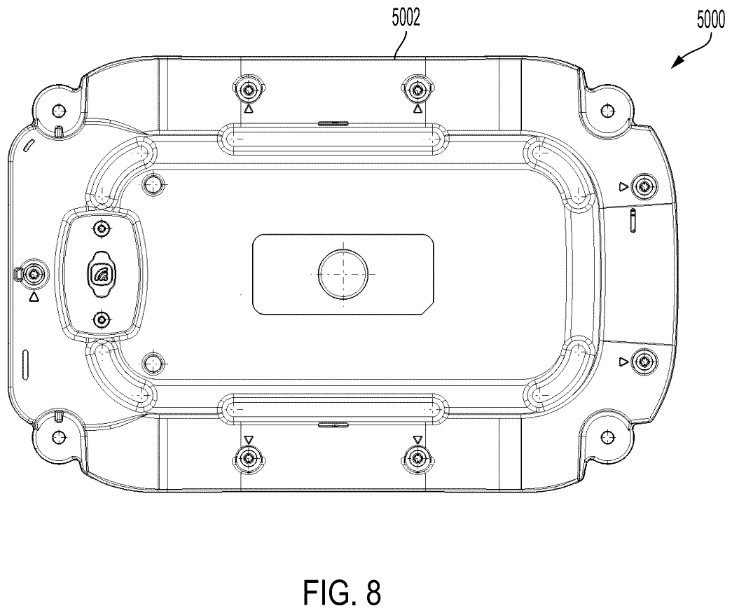

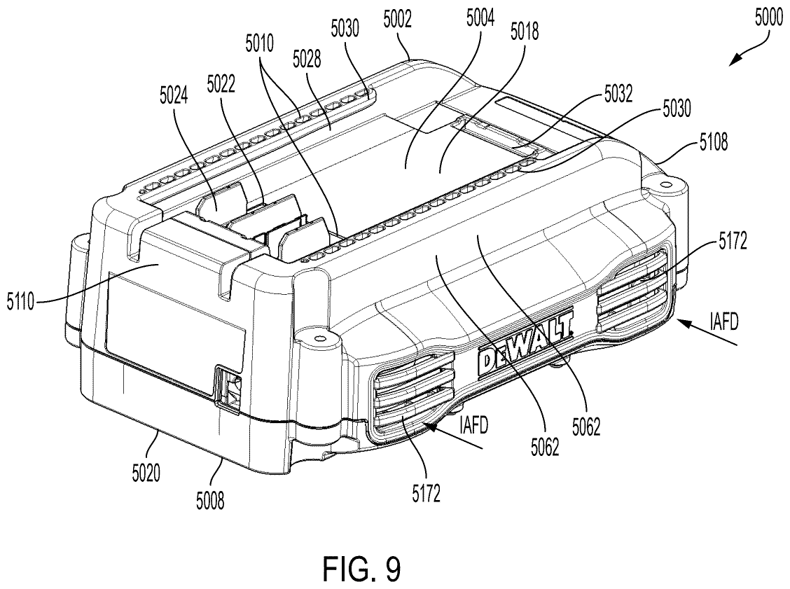

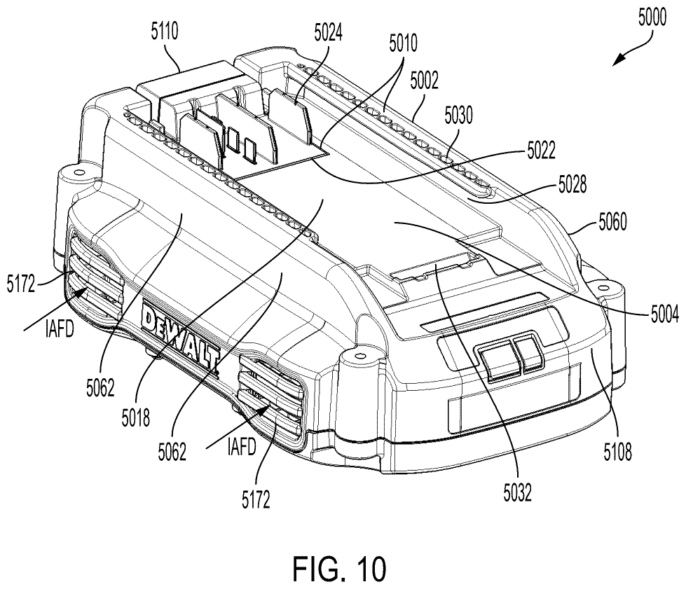

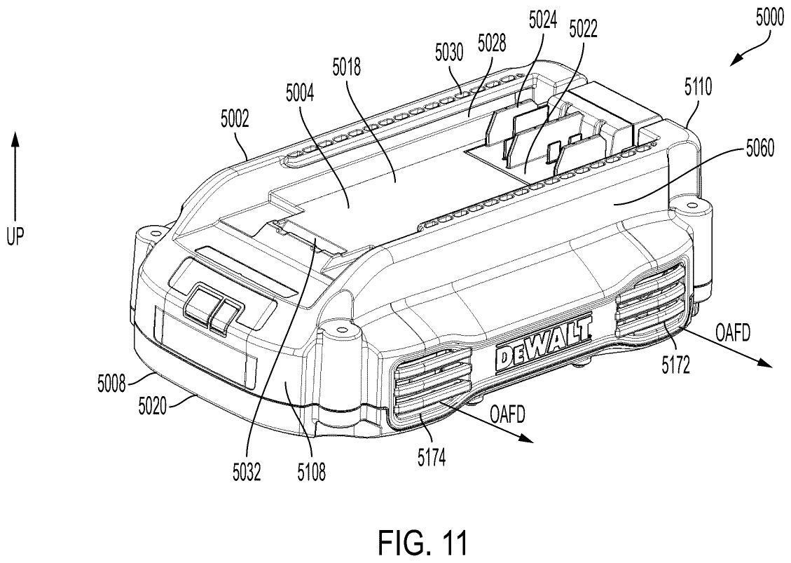

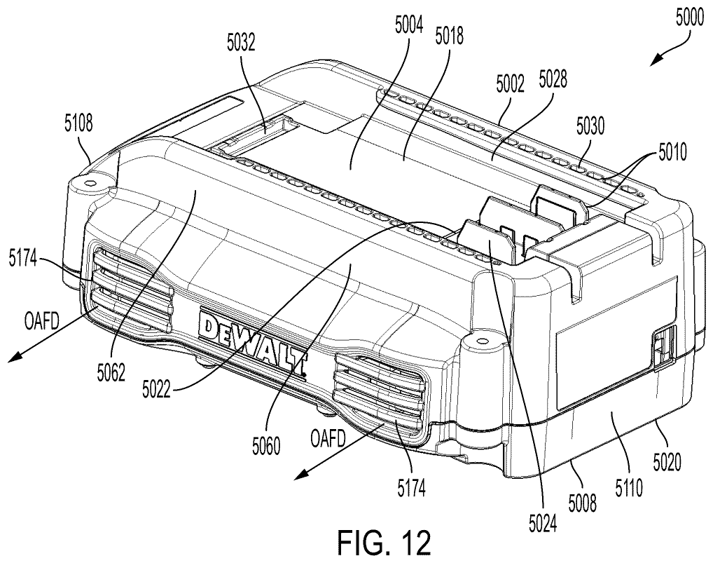

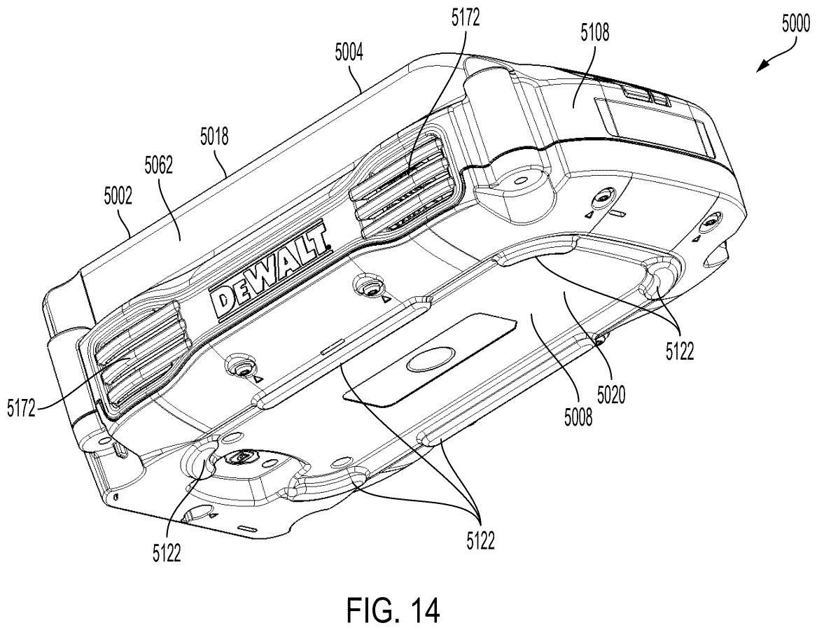

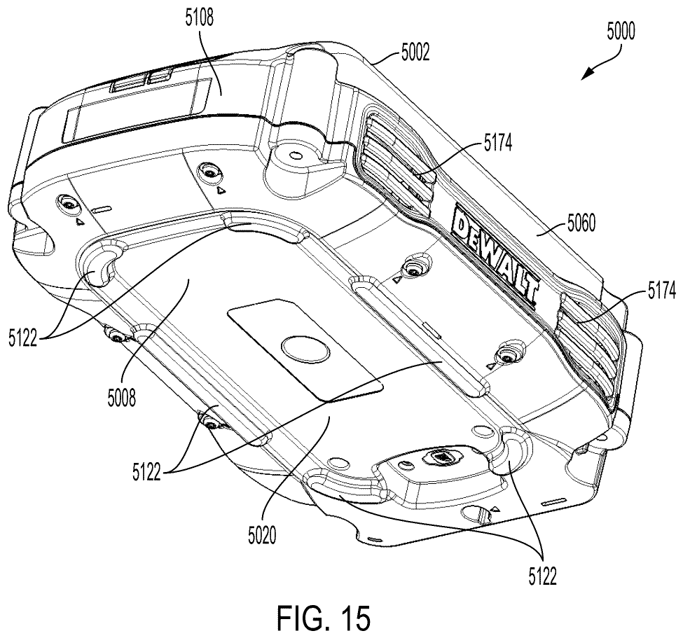

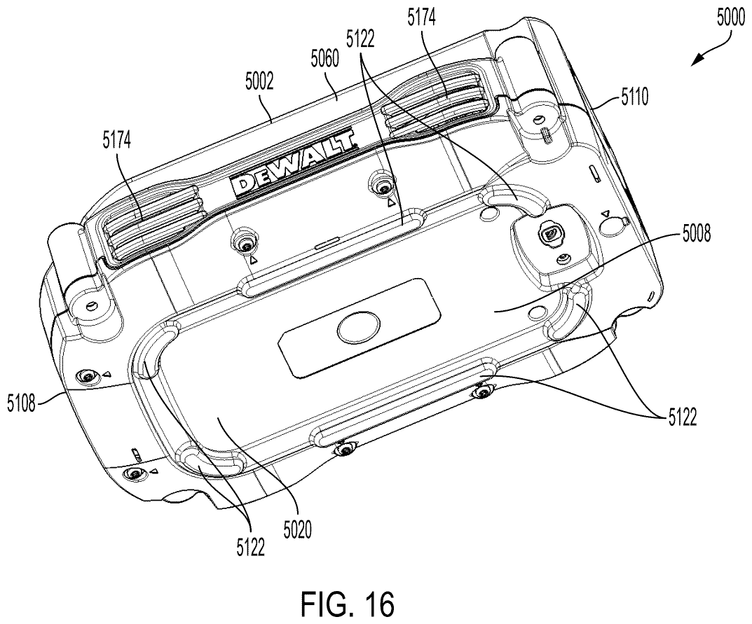

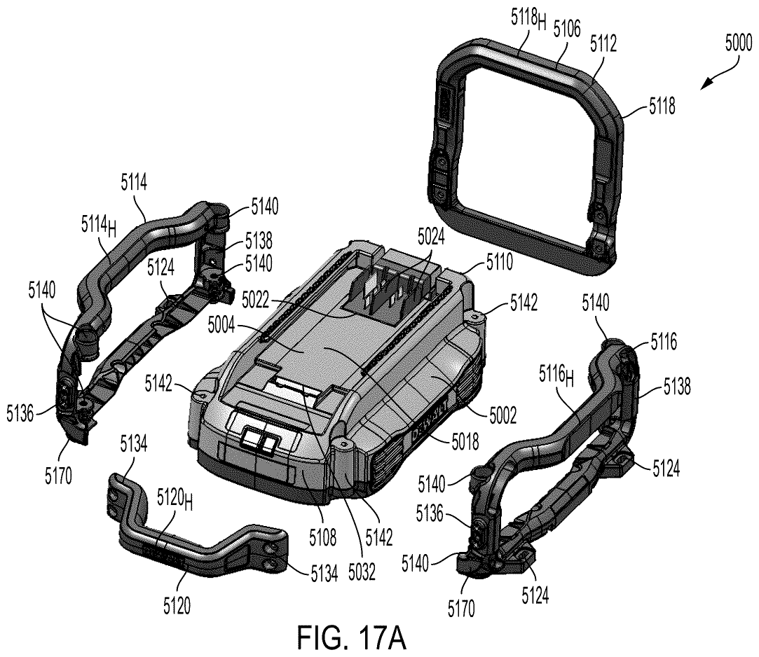

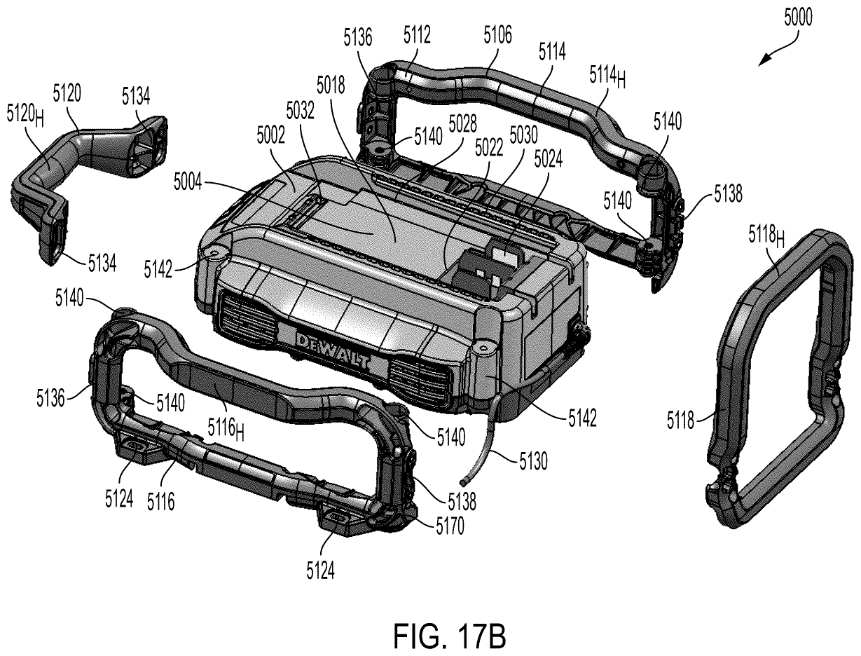

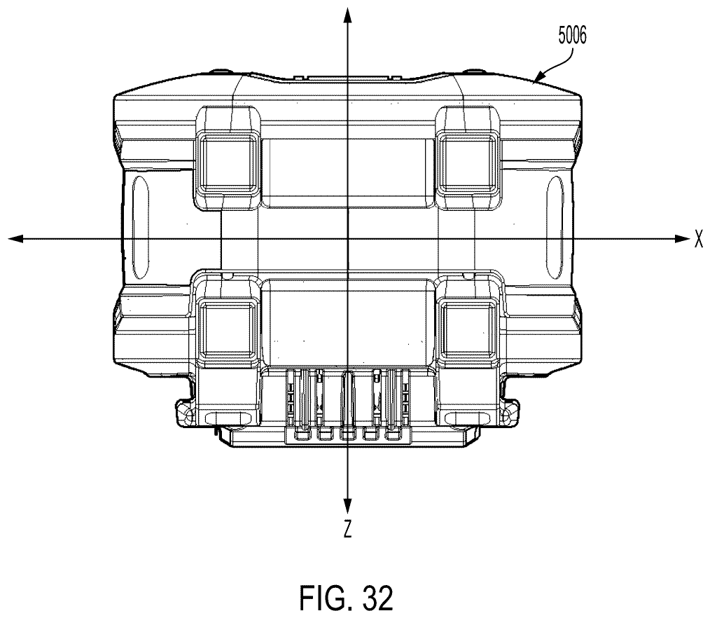

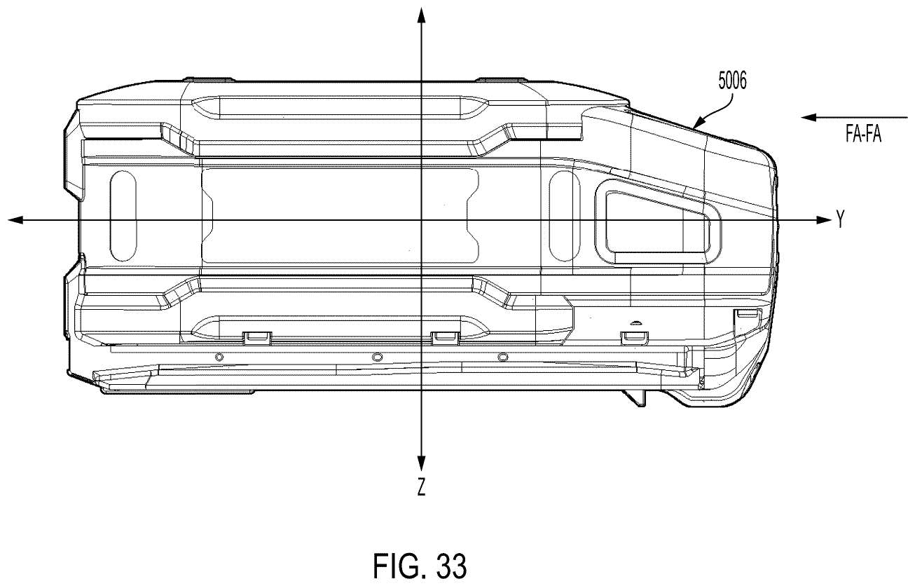

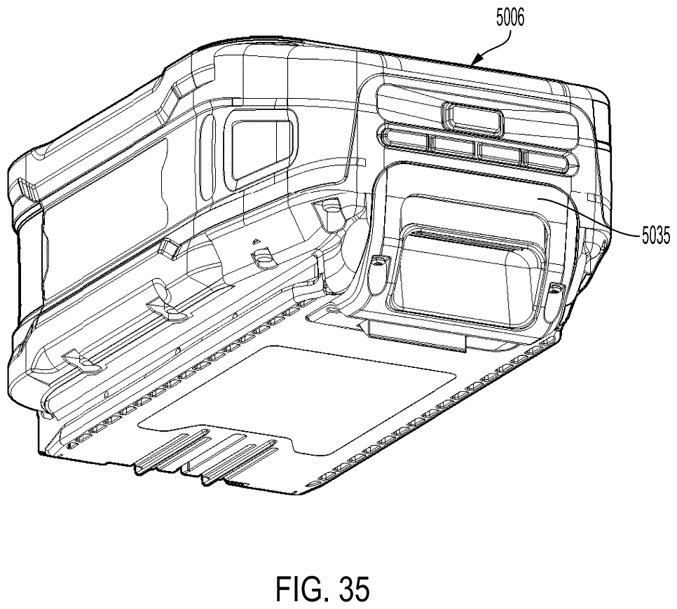

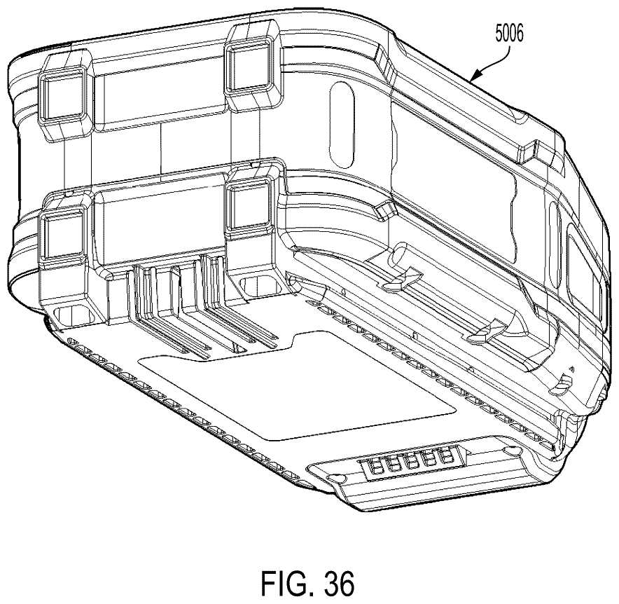

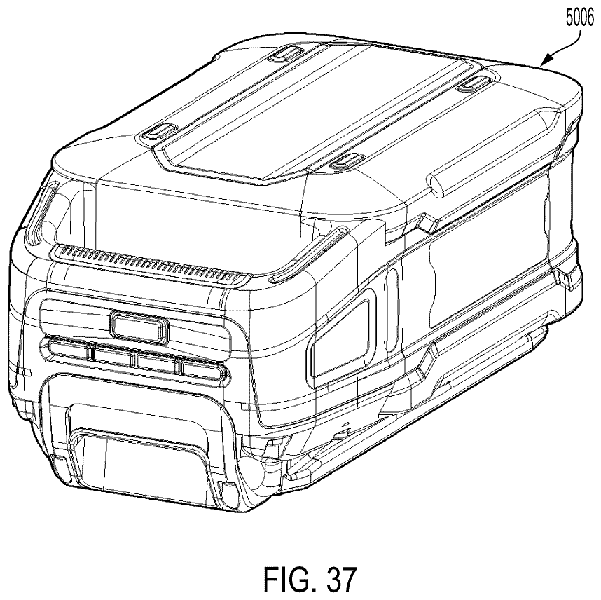

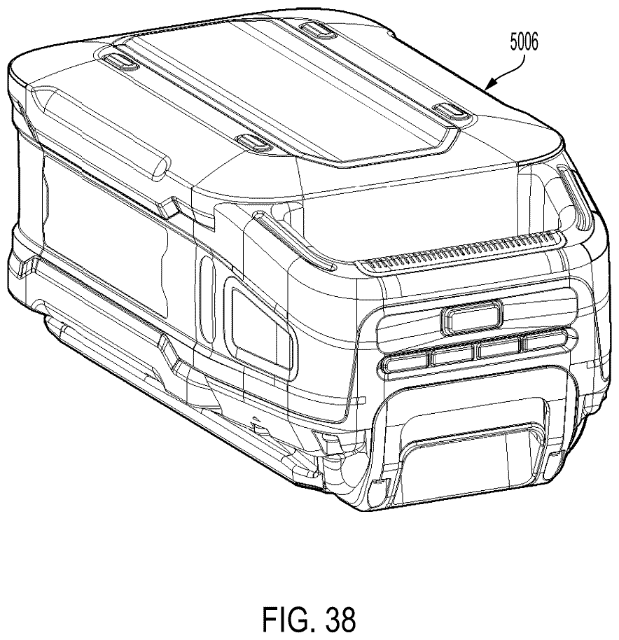

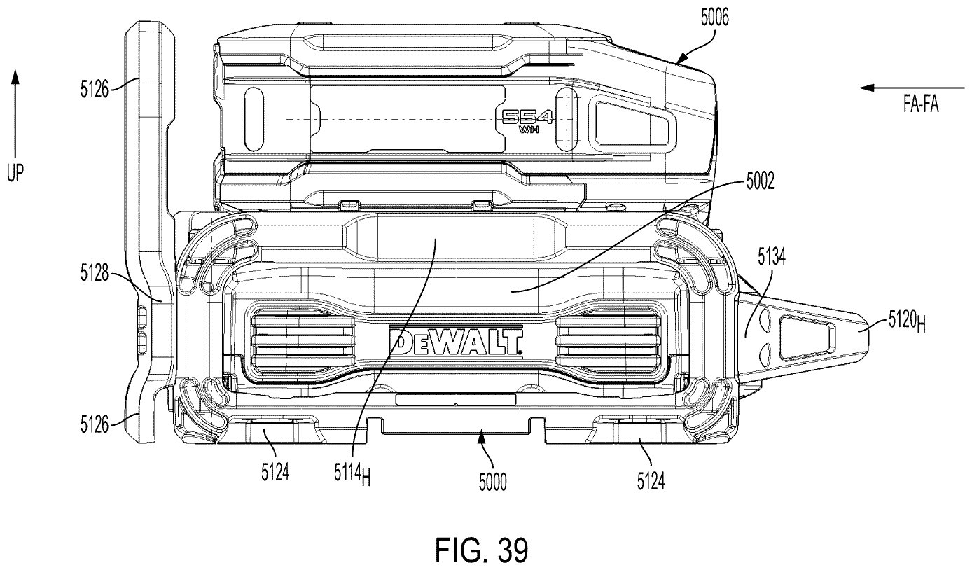

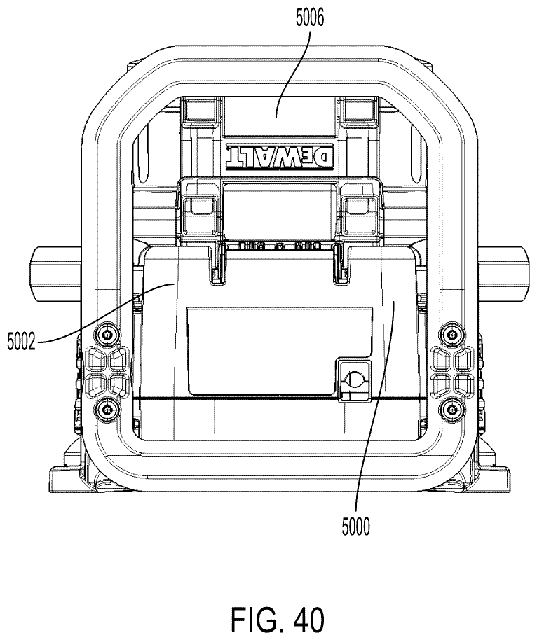

The present patent application provides a battery pack charger 5000 that is configured to be electrically and mechanically connectable to a battery pack 5006 and to be able to charge the battery pack 5006. FIGS. 3-16 show various views of the charger 5000. FIGS. 32-38 show various views of the battery pack 5006. The charger 5000 may be referred to as an electrical device. The charger 5000 may be configured for charging the battery pack 5006 (i.e., a rechargeable DC power supply) with an AC line power supply/source. A power cord 5130 (shown in FIG. 17B) may be configured to attach the charger 5000 to the AC line power supply/source.

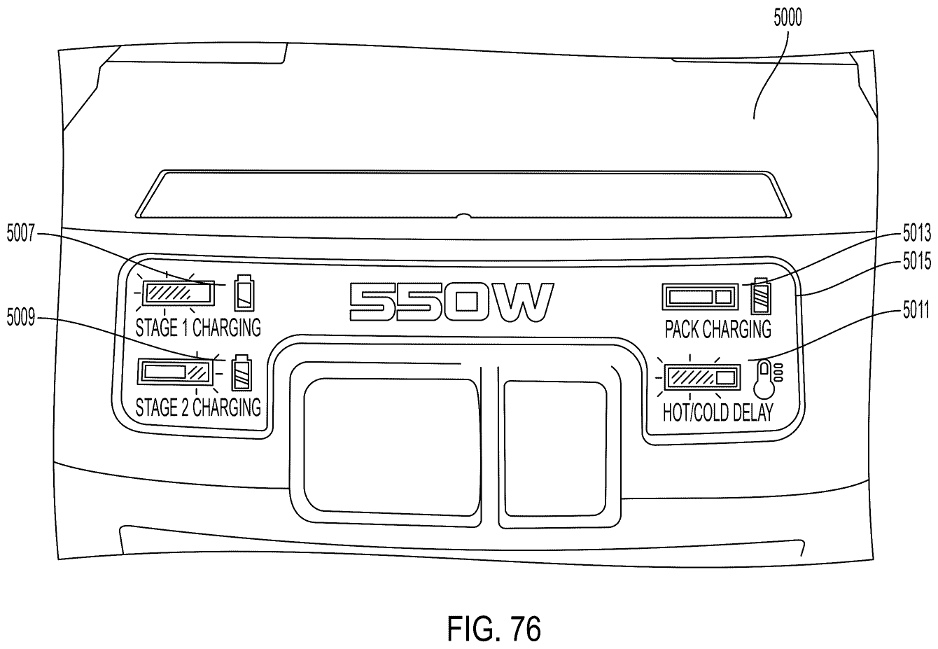

The charger 5000 may include an LED display having a plurality of LEDs thereon. When charging the battery pack 5006, the LEDs 5005 (as shown in FIG. 3) may illuminate to indicate the status of the battery pack 5006. For example, referring to FIG. 76, the LED display/user interface 5015 may include stage 1 charging indicator 5007, stage 2 charging indicator 5009, hot/cold delay indicator 5011, and a battery pack charging indicator 5013.

The charger 5000 may have different voltage charging points (voltages). For example, the charger 5000 may have a voltage charging point, such as a high voltage charging point (54V) to match the rated voltage (54V) of the battery pack 5006.

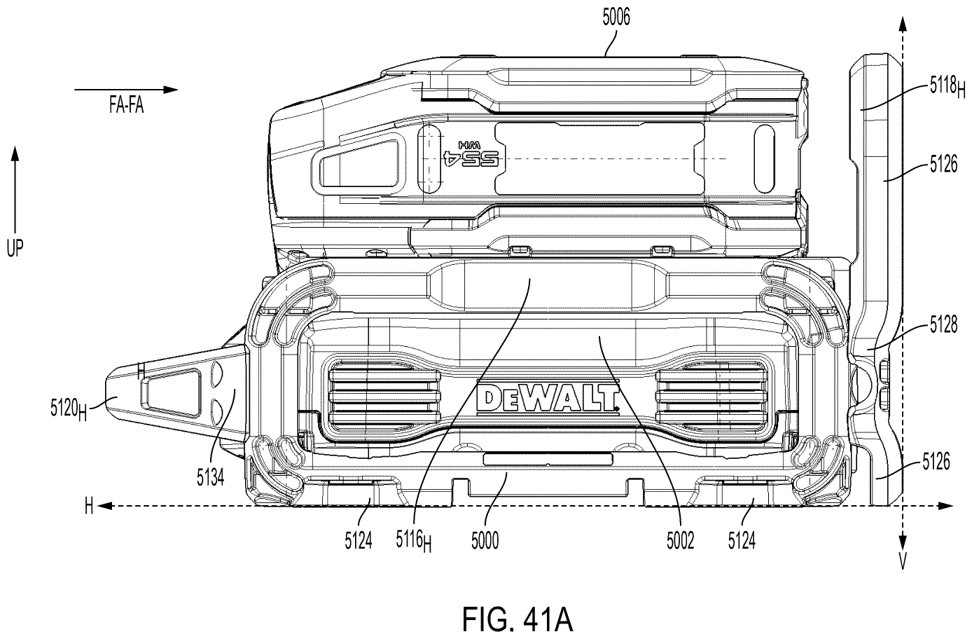

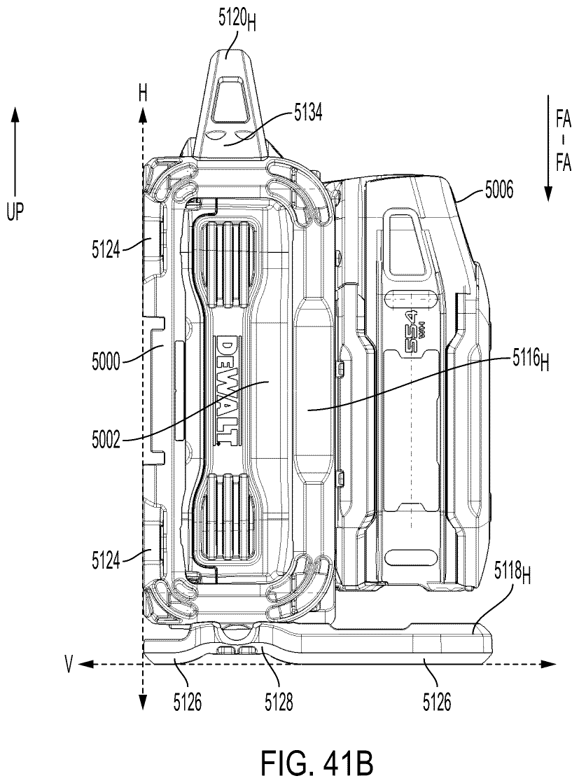

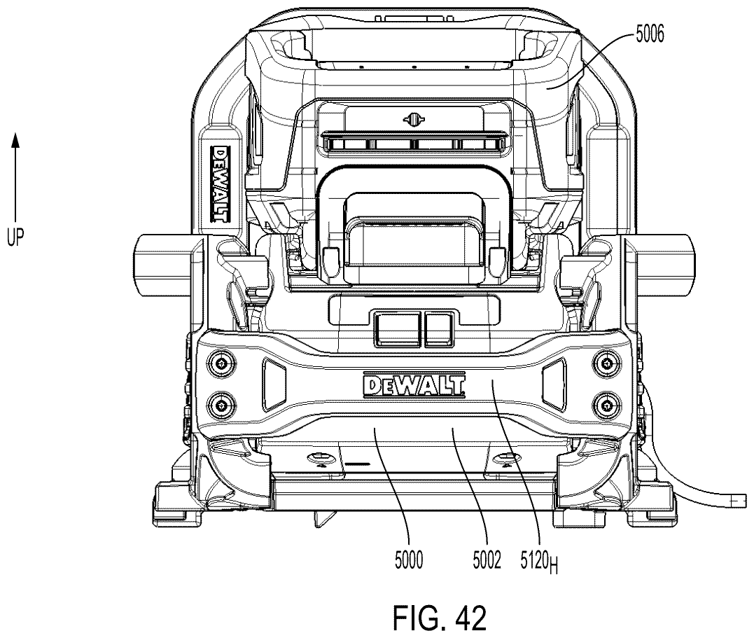

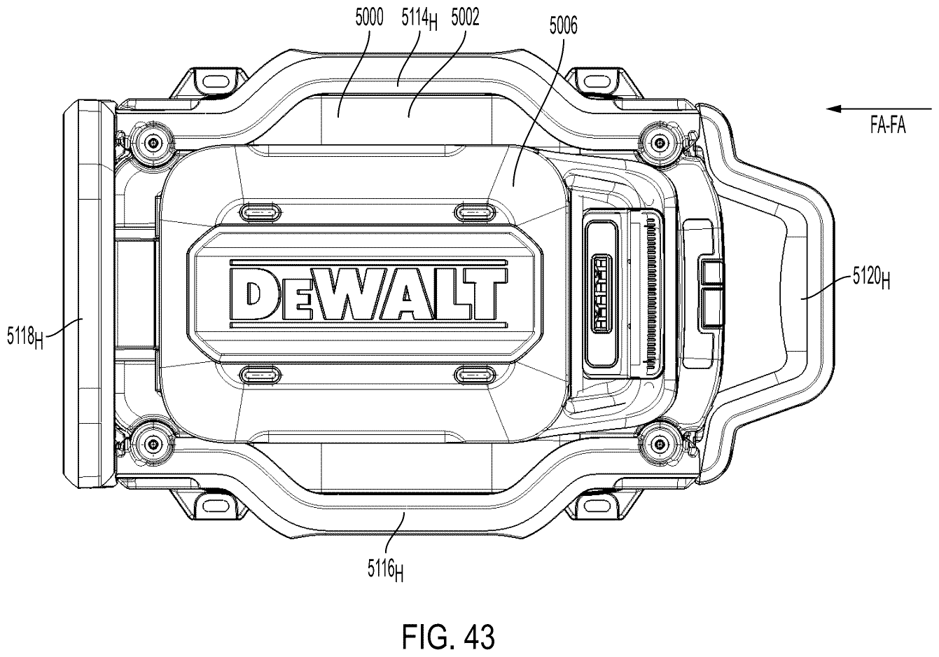

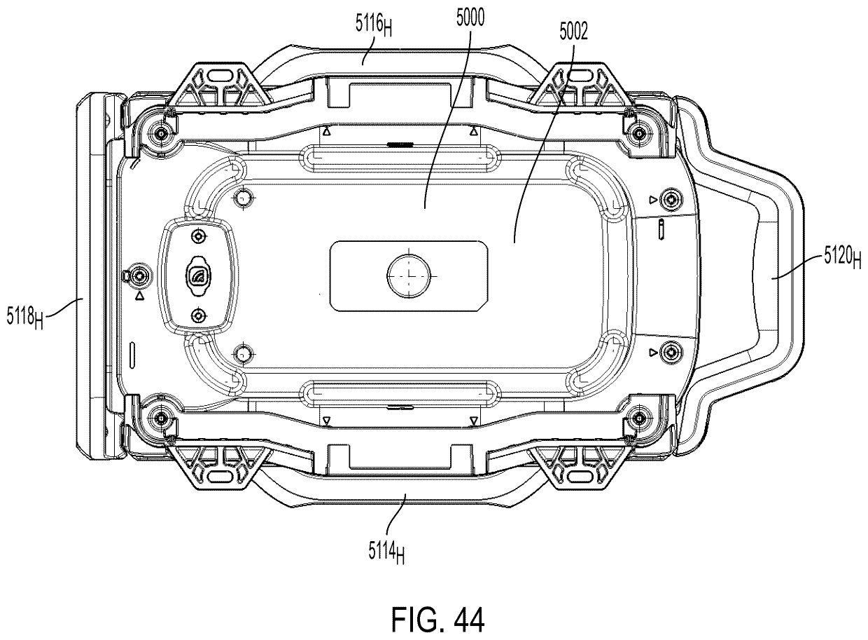

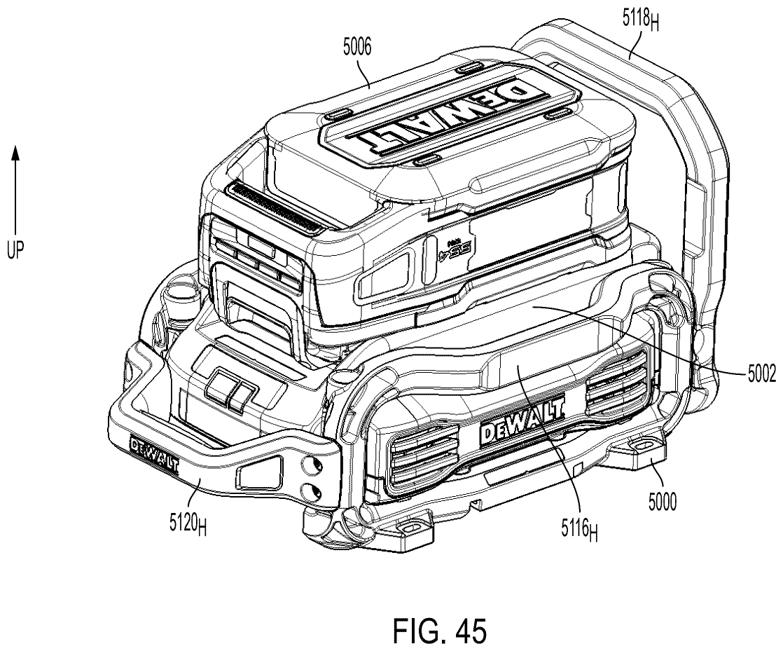

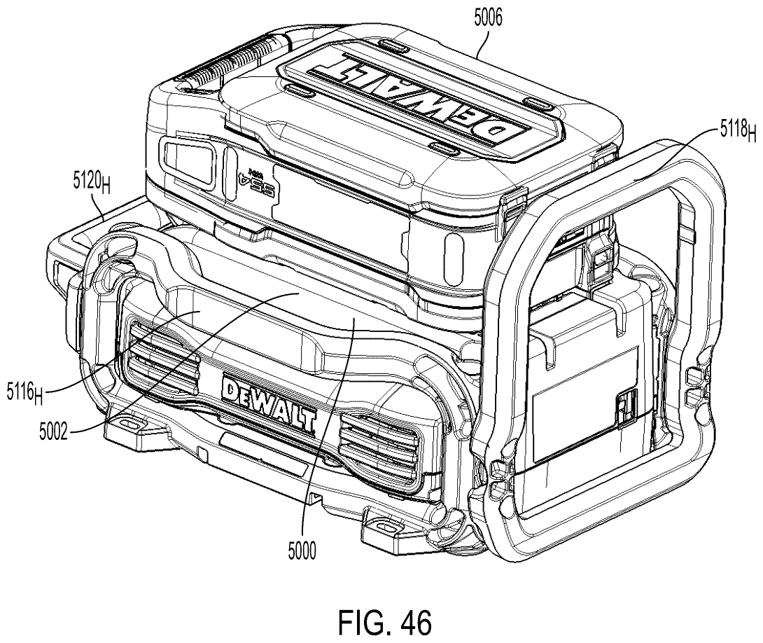

The charger 5000 may include a housing 5002. The housing 5002 may include a first side 5004 and a second side 5008, opposed to the first side 5004. The first side 5004 may include a top 5018 of the charger 5000 and the second side 5008 may include a bottom 5020 of the charger 5000, for example, when the charger 5000 is disposed such that the battery pack insertion direction FA-FA is generally horizontal as shown in FIG. 41A. The housing 5002 may include two pairs of opposing sides 5060, 5062 (referred to as third and fourth sides of the housing 5002), and 5108, 5110 (may be referred to fifth and sixth sides of the housing 5002). For example, the side 5108 may form the front of the charger 5000 and side 5110 may form the rear/back of the charger 5000. The housing 5002 may be made of Acrylonitrile Butadiene Styrene (ABS) material. The housing 5002 may be made of a high/hard impact plastic material.

The housing 5002 may include a first housing portion and a second housing portion that are connected together to form the charger housing 5002 with an internal cavity therein. The first and second housing portions may include upper/top and lower/bottom housing portions. The first and second housing portions may include left side and right side housing portions. On the first side 5004, the charger 5000 may include an open deck cavity formed by the housing 5002 for receiving the battery pack 5006.

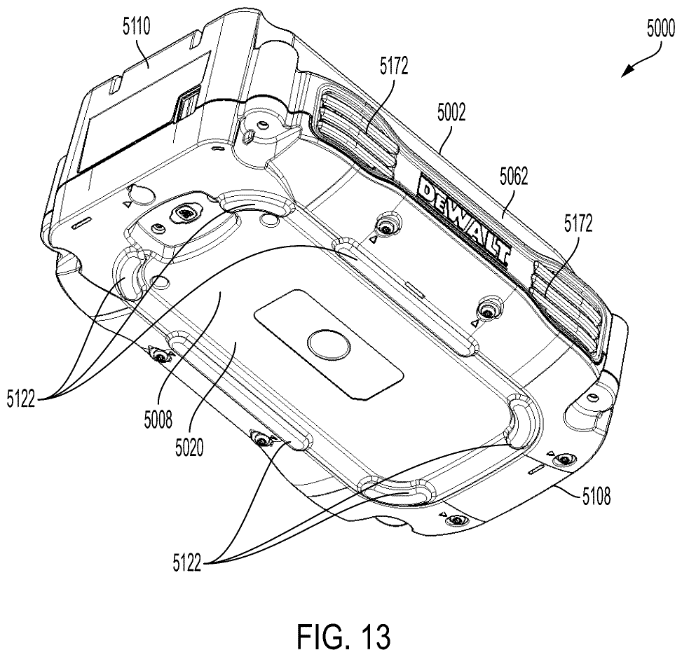

Referring to FIGS. 13-16, the second side 5008 of the housing 5002 (i.e., bottom 5020 of the charger 5000) may include feet 5122 thereon. The feet 5122 may function as spacers 5122 between the bottom 5020 of the charger 5000 and a top 5042 of a coupling plate 5016 when the coupling plate 5016 is attached on the second side 5008 of the housing 5002. The coupling plate 5016 will be described in detail in the discussions below. The spacers 5122 may be configured to space the top 5042 of the coupling plate 5016 (or position the top 5042 of the coupling plate 5016 by a certain distance) from the bottom 5020 of the charger 5000 when the coupling plate 5016 is attached on the second side 5008 of the housing 5002.

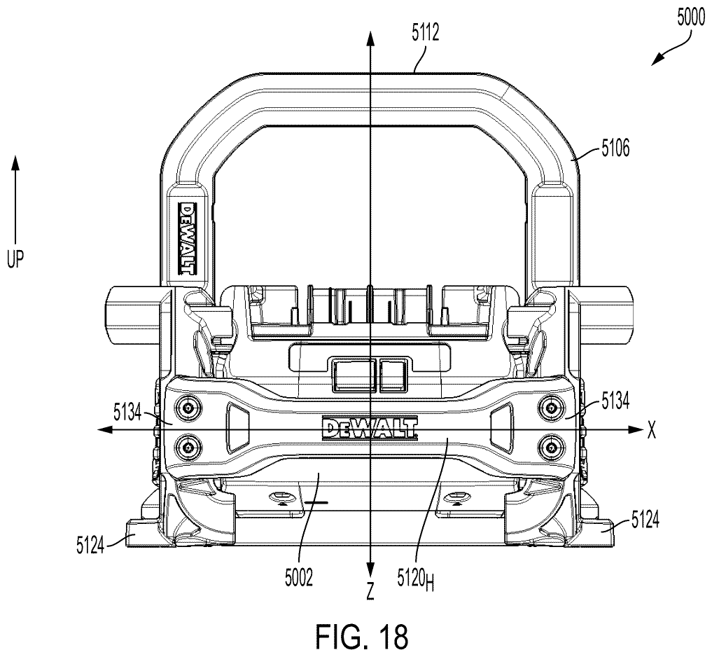

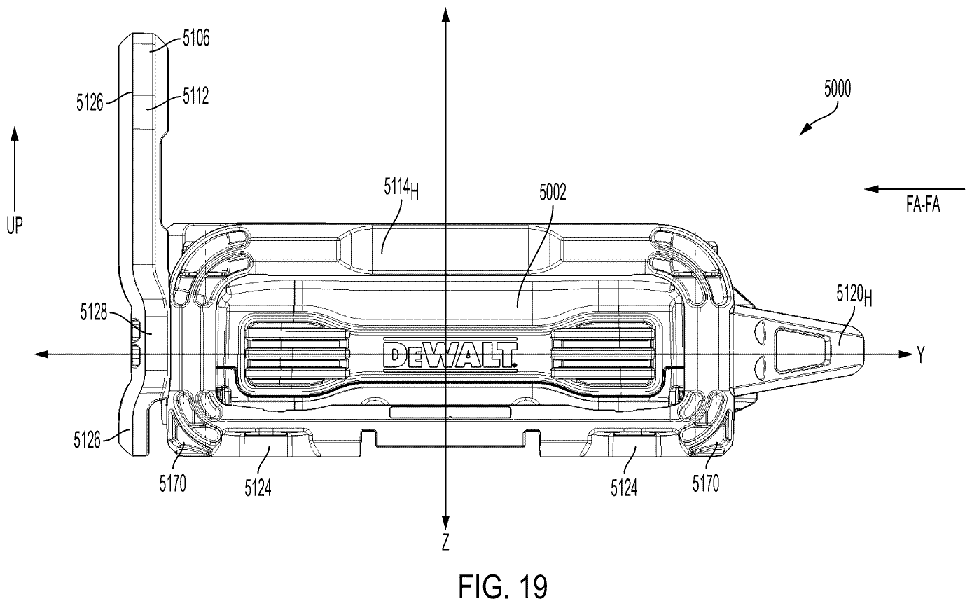

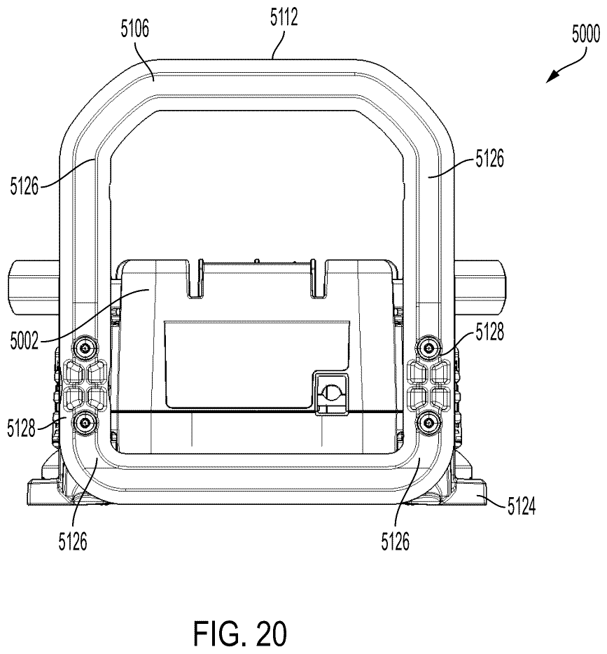

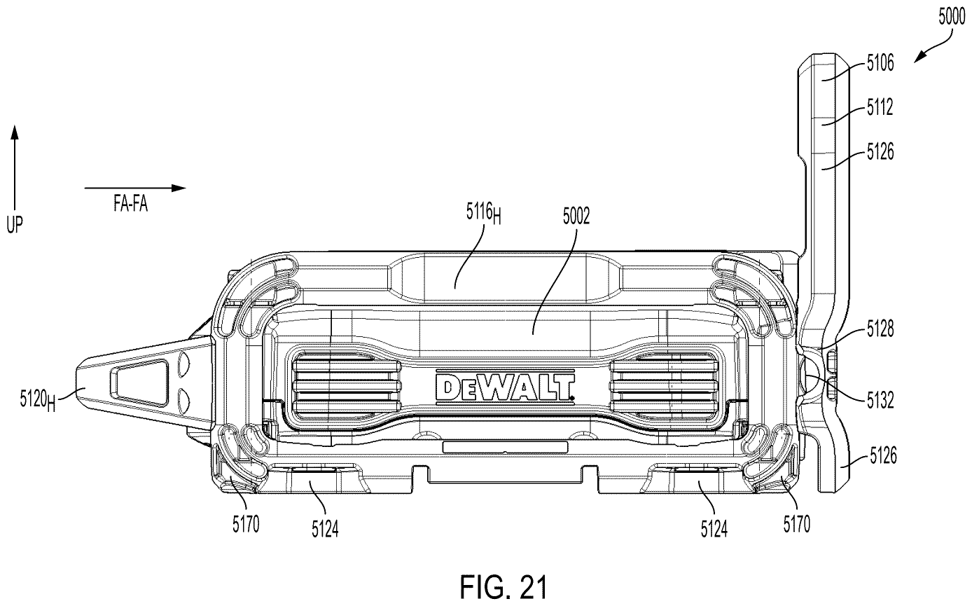

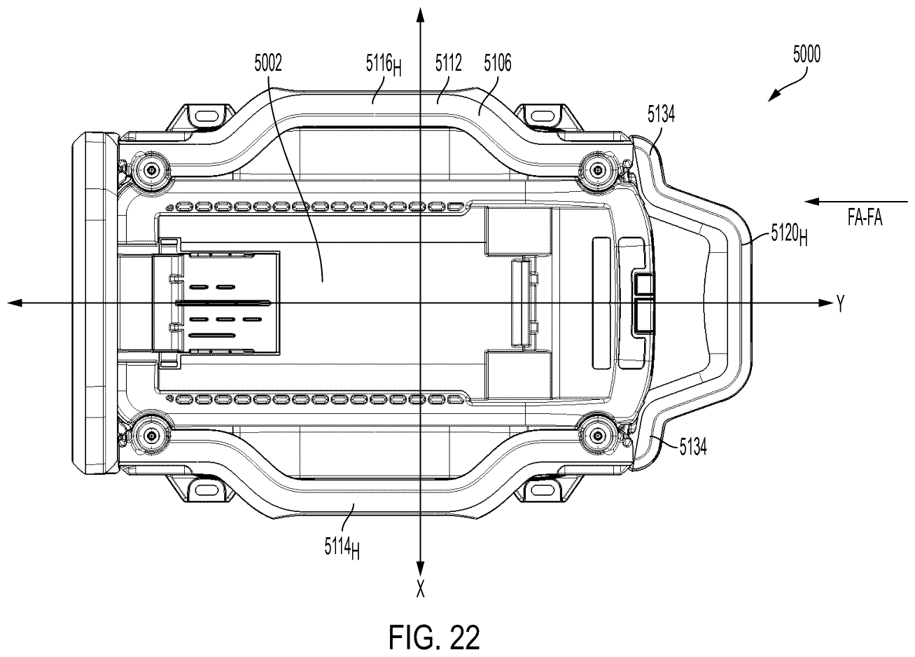

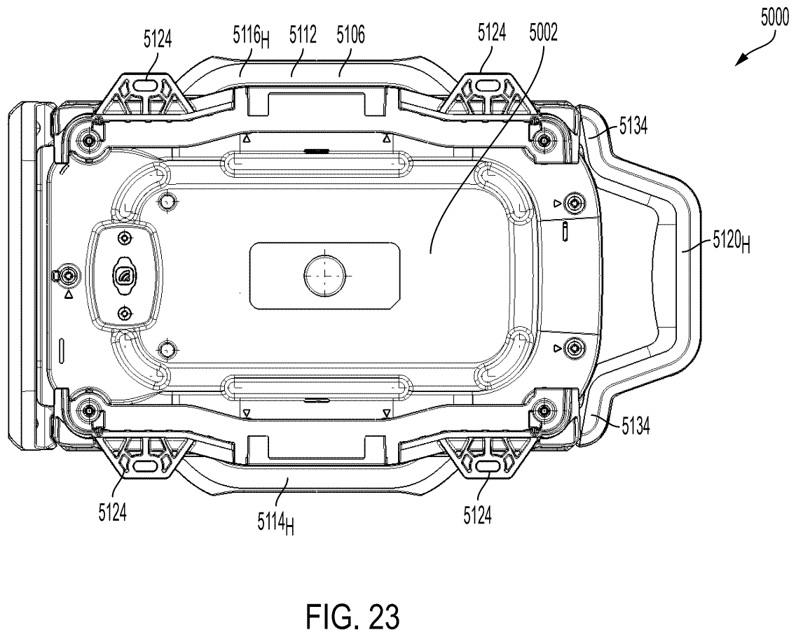

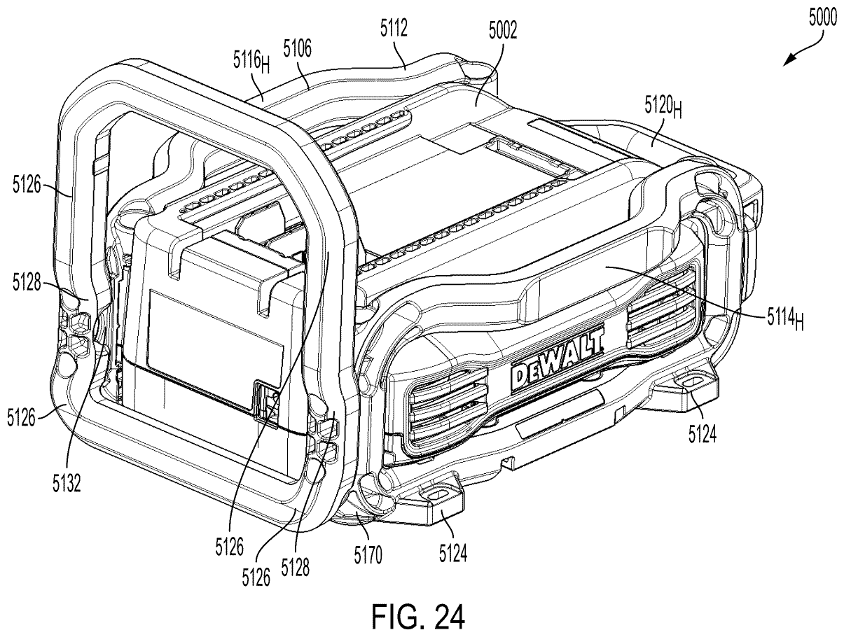

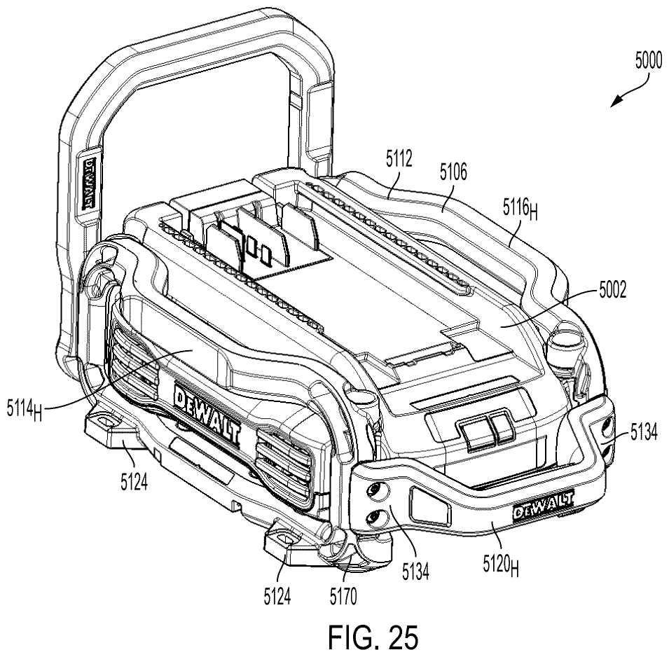

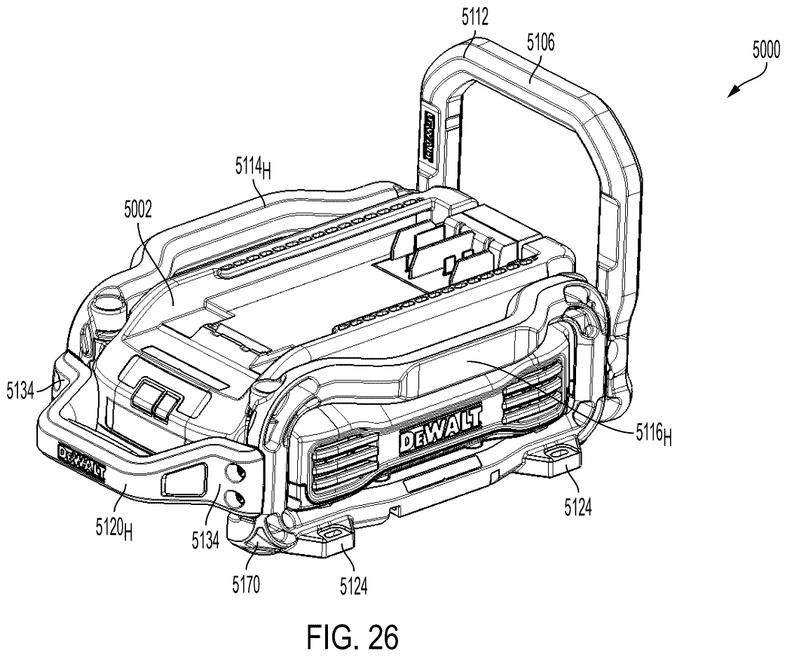

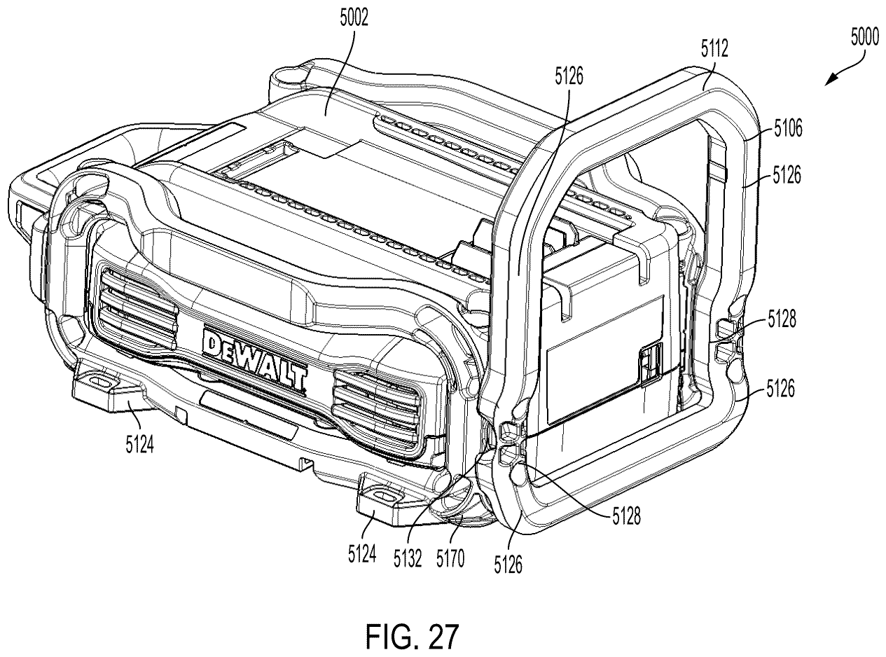

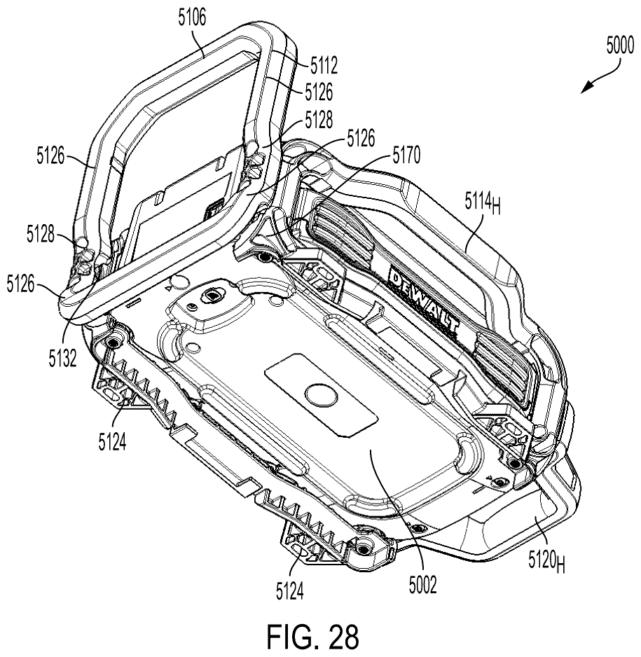

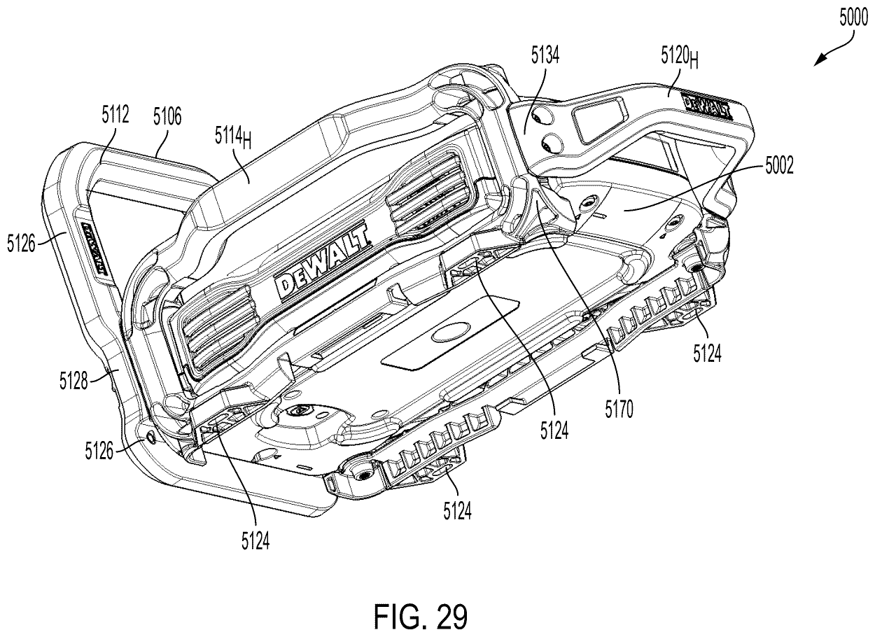

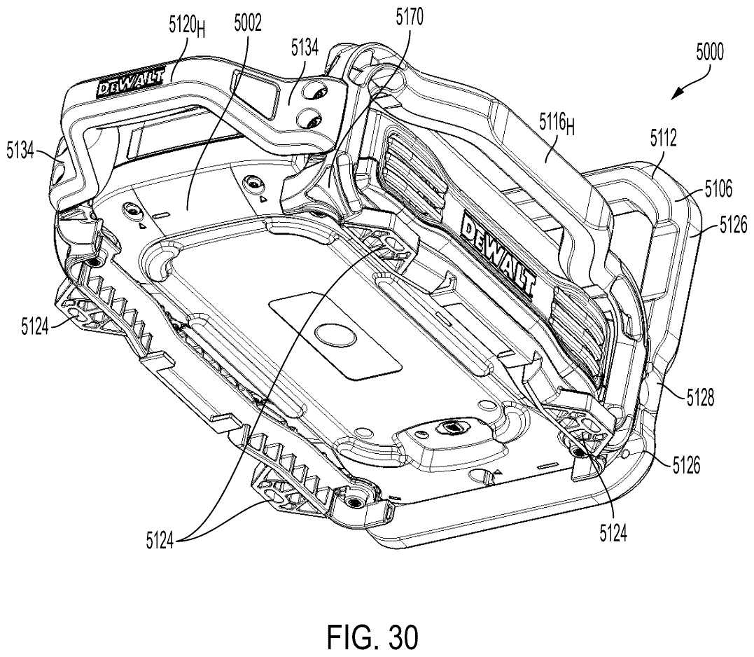

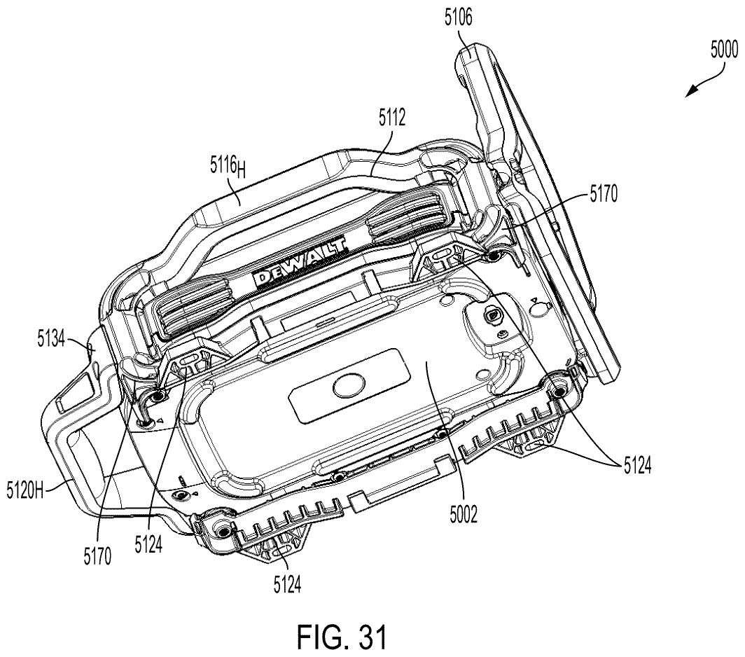

Referring to FIGS. 17A-31, the housing 5002 may be at least partially enclosed/surrounded by a roll cage 5106 to protect the charger 5000 from inadvertent damage. That is, the charger 5000 may include the roll cage 5106 affixed to the housing 5002. FIGS. 17A-17B show the roll cage 5106 separate from the charger 5000 and before the roll cage 5106 is attached to the charger 5000.

The roll cage 5106 may be configured to at least partially enclose/surround the charger 5000. The roll cage 5106 may include a roll cage frame 5112 defined by substantially tubular members 5114, 5116, 5118, 5120. The tubular members 5114, 5116, 5118 may have rectangular shaped configurations. The tubular members 5114, 5116, 5118 may have other shaped configurations. The tubular member 5120 may have a U-shaped configuration. The tubular members 5114, 5116, 5118, 5120 of the roll cage 5106 may be made of a metal material. The tubular members of the roll cage 5106 may be disposed on four sides of the charger 5000 for protecting the charger 5000. The four sides may include the pair of opposing sides 5108, 5110 (that include the front and rear of the charger 5000) and the pair of opposing sides 5060, 5062. The tubular members of the roll cage 5106 may be disposed on five sides of the charger 5000 for protecting the charger 5000. The five sides may include the pair of opposing sides 5108, 5110 (that include the front and rear of the charger 5000), the pair of opposing sides 5060, 5062, and the second side 5008 of the housing 5002 (that includes the bottom 5020 of the charger 5000).

The roll cage frame 5112 may include a pair of opposing side frame portions 5114, 5116 that are spaced from and substantially parallel to each other. Each of the pair of opposing side frame portions 5114, 5116 may include feet portions 5124 (at least two are shown for each) to provide stable support for the charger 5000 when it is in a first orientation (in which the battery pack insertion direction FA-FA is generally horizontal). Each of the pair of opposing side frame portions 5114, 5116 may include end feet portions 5170 (at least two are shown for each) to provide stable support for the charger 5000 when it is in the first orientation.

The roll cage frame 5112 may also include a rear frame portion 5118 that is disposed in a plane that is generally perpendicular to planes of the pair of opposing side frame portions 5114, 5116. The rear frame portion 5118 may include support portions 5126 and connector portions 5128. The connector portions 5128 may protrude inwardly towards the housing 5002 (compared to the support portions 5126) and the connector portions 5128 may be configured to connect the rear frame portion 5118 to the pair of opposing side frame portions 5114, 5116. The support portions 5126 may be disposed on either sides of each of the connector portion 5128. The support portions 5126 may be configured to provide stable support for the charger 5000 when the charger is in a second orientation in which the battery pack insertion direction FA-FA is generally vertical. The rear frame portion 5118 may also include a recess 5132 for passage of the power cord past the roll cage 5100, in general, and the end frame portion 5118 and the side frame portion 5116. A fore frame portion 5120 may include connector portions 5134 at its ends that are configured to connect the fore frame portion 5120 to the pair of opposing side frame portions 5114, 5116.

As shown in FIGS. 17A-17B, each pair of opposing side frame portions 5114, 5116 may have connector portions 5136 that are configured to connect the pair of opposing side frame portions 5114, 5116 to the fore frame portion 5120. The pair of opposing side frame portions 5114, 5116 may also have connector portions 5138 that are configured to connect the pair of opposing side frame portions 5114, 5116 to the rear frame portion 5118. The pair of opposing side frame portions 5114, 5116 may further have connector portions 5140 (that align with portions 5142 on the housing 5002) that are configured to connect the pair of opposing side frame portions 5114, 5116 to the housing 5002. The connector portions 5140 of the pair of opposing side frame portions 5114, 5116 may extend inwardly from their respective side frame portions 5114, 5116 toward the housing 5002 to align the connector portions 5142 on the housing 5002. Mechanical fasteners (e.g., screws, etc.) may be inserted through the corresponding connector portions after they are aligned, for connecting (1) the pair of opposing side frame portions 5114, 5116 to the fore frame portion 5120 (2) the pair of opposing side frame portions 5114, 5116 to the rear frame portion 5118, and (3) the pair of opposing side frame portions 5114, 5116 to the housing 5002.

As discussed in detail below, the roll cage 5106 may further provide grips or handles allowing a user or users to lift the charger 5000 for transport. The roll cage 5106 may include a plurality of handles 5114_{H}, 5116_{H}, 5118_{H}, 5120_{H} to enable carrying the charger 5000 with a battery pack insertion direction FA-FA being vertical (as shown in FIG. 41B) or with the battery pack insertion direction FA-FA being horizontal (as shown in FIG. 41A). For example, the roll cage 5106 may include at least one handle 5120_{H} to enable carrying the battery pack charger 5000 with a battery pack insertion direction FA-FA being vertical (as shown in FIG. 41B) and at least one handle 5114_{H}, 5116_{H} to enable carrying the battery pack charger 5000 with the battery pack insertion direction FA-FA being horizontal (as shown in FIG. 41A).

Each of the plurality of handles 5114_{H}, 5116_{H}, 5118_{H}, 5120_{H} may be ergonomically designed to be contoured to a user's hand. The plurality of handles 5114_{H}, 5116_{H}, 5118_{H}, 5120_{H} of the roll cage 5106 may include the first handle 5120_{H} positioned at the front side 5108 of the housing 5002. The first handle 5120_{H} may be part of the fore frame portion 5120. The first handle 5120_{H} may be configured to extend outwardly from the front side 5108 of the charger 5000. As shown in FIG. 41B, the first handle 5120_{H} may be configured for carrying the charger 5000 when the battery pack insertion direction FA-FA is vertical.

The plurality of handles 5114_{H}, 5116_{H}, 5118_{H}, 5120_{H} of the roll cage 5106 may also include a second handle 5118_{H} positioned at the rear side 5110 of the housing 5002 and a pair of side handles 5114_{H}, 5116_{H} positioned at each of the opposing sides 5060, 5062 of the housing 5002. The second handle 5118_{H} may be a part of the rear frame portion 5118. The pair of side handles 5114_{H}, 5116_{H} may be part of the pair of opposing side frame portions 5114 and 5116, respectively. The pair of side handles 5114_{H}, 5116_{H} of the roll cage 5106 may be configured for carrying the charger 5000 when the battery pack insertion direction FA-FA is horizontal. The second handle 5118_{H} may be optional.

Each of the side handles 5114_{H}, 5116_{H} of the roll cage 5106 may be configured to extend outwardly from their respective sides 5114, 5116 so as to accommodate user's fingers to allow the user to lift the charger 5000 for transport.

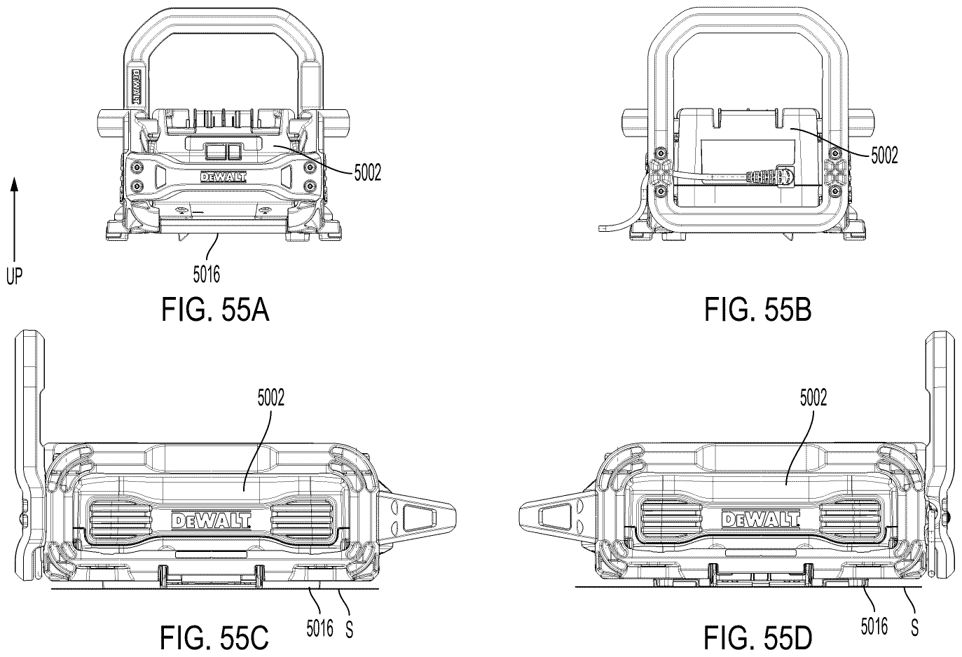

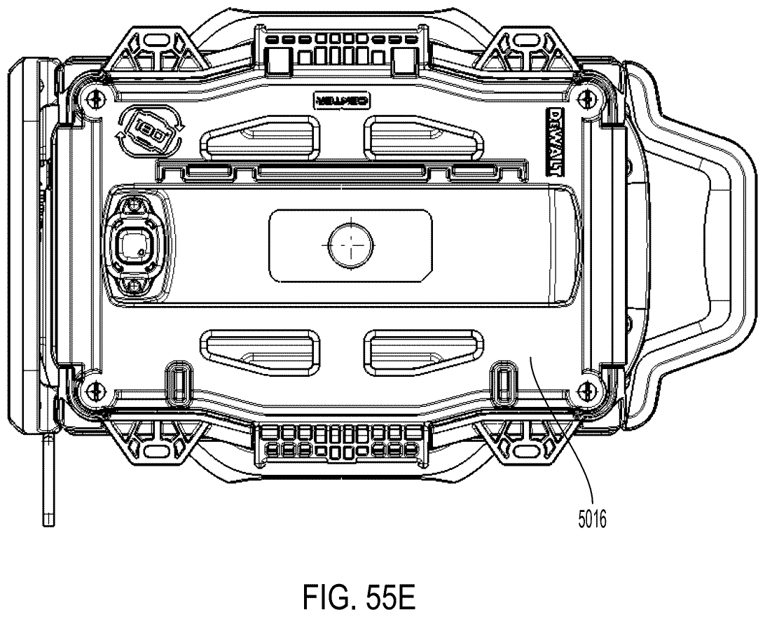

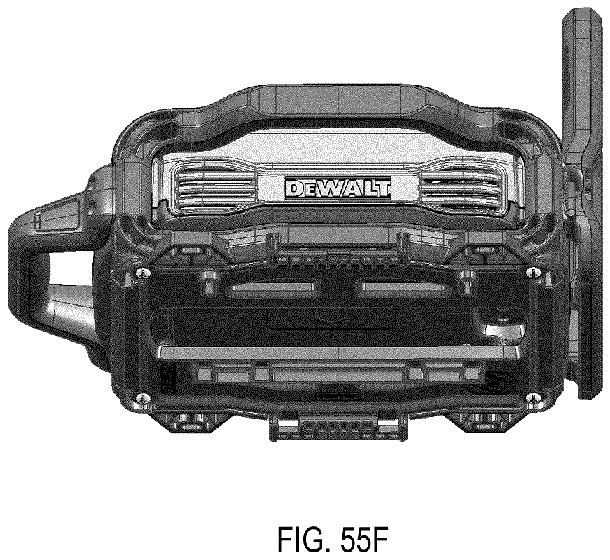

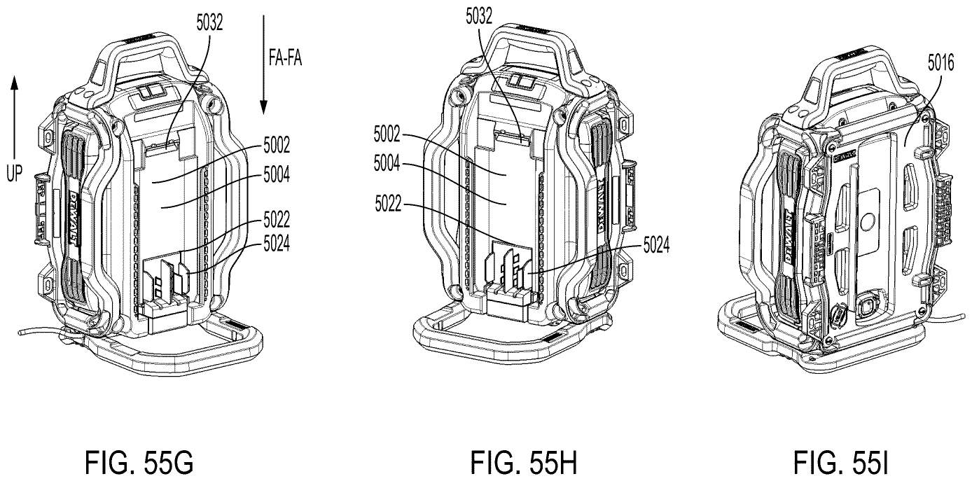

The feet portions 5124 of the side frame portions 5114, 5116 of the roll cage 5106 may be configured to provide stable support for the charger 5000 when the charger 5000 is in the first orientation. The feet portions 5124 of the roll cage 5106 may extend outwardly away from the side frame portions 5114, 5116 and/or the housing 5002 to provide stable support for the charger 5000 when the charger 5000 is in the first orientation. For example, as shown in FIGS. 55C and 55D, the bottom 5044 of the coupling plate 5016 may be configured to provide stable support for the first orientation when the coupling plate 5016 is attached to the charger 5000.

As shown in FIG. 41B, the roll cage 5106 may be configured to provide stable support for a second orientation of the charger 5000 in which the battery pack insertion direction FA-FA is generally vertical. The rear frame portion 5118 of the roll cage 5106 may be configured to provide stable support for the second orientation. The support portions 5126 of the rear frame portion 5118 may be configured to provide stable support for the charger 5000 when the charger 5000 is in the second orientation.

The first side 5004 of the charger 5000 may include a first interface 5010 configured to receive/mate/couple with the battery pack 5006 along a first axis FA-FA. The first axis FA-FA may include a horizontal insertion direction of the battery pack 5006 when the charger 5000 is positioned in a horizontal orientation (as shown in FIG. 41A). The first axis FA-FA may also include a vertical insertion direction of the battery pack 5006 when the charger 5000 is positioned in a vertical orientation (as shown in FIG. 41B).

The first interface 5010 of the charger 5000 may be configured to facilitate interconnections with the battery pack 5006. The first interface 5010 may include a terminal block 5022 and a plurality (or a set) of terminals 5024 configured for engagement along the first axis FA-FA with the battery pack 5006 and configured to provide an electrical interconnection with the battery pack 5006. The set of terminals 5024 of the charger 5000 may be disposed within the open deck cavity for providing electrical connections between the charger 5000 and the battery pack 5006. The charger terminals 5024 are configured to electrically couple to the set of battery pack terminals to provide power from the charger 5000 to the plurality of battery cells in the battery pack 5006. For example, the charger terminals 5024 may include charger power terminals 5024_{P} and charger signal terminals 5024_{S}. The set of charger terminals 5024 may include two power terminals 5024_{P} and five signal terminals 5024_{S}. The number of charger signal terminals may vary. The charger power terminals 5024_{P} may include a +terminal, and a −terminal. The charger signal terminals 5024_{S} may also be referred to as communications (COMM) terminals.

The first interface 5010 may also include a rail interface portion 5026 configured for engagement along the first axis FA-FA to the battery pack 5006 and configured to provide a physical interconnection with the battery pack 5006. The rail interface portion 5026 may include a pair of grooves 5028 and a pair of rails 5030. The first interface 5010 may also include a catch 5032. The grooves 5028, the rails 5030 and the catch 5032 may be disposed on the first side 5004 of the housing 5002.

The grooves 5028 of the charger 5000 may be configured to receive corresponding rails of the battery pack 5006 and the rails 5030 of the charger 5000 may be configured to be received in corresponding grooves of the battery pack 5006 when the battery pack 5006 slidingly engages/couples with the charger 5000. That is, the set of rails and the set of grooves of the battery pack 5006 may be configured to engage with the set of grooves 5028 and the set of rails 5030 of the charger 5000 to assist in mechanically coupling the battery pack 5006 and the charger 5000 together. The battery pack 5006 may include a slide type battery pack. The battery pack 5006 may have a capacity of 10 Ah, an impedance of equal to or less than approximately 3 milliohms, and a nominal voltage of 54V. The battery pack 5006 may include a plurality of battery cells connected in series (strings) and/or a plurality of strings of cells connected in parallel with one another.

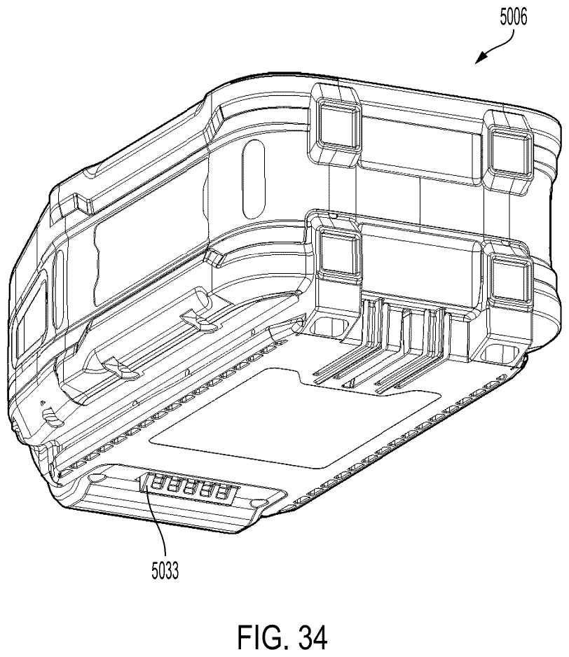

The catch 5032 of the charger 5000 may be configured to engage with a latch 5033 (as shown in FIG. 34) disposed on the battery pack 5006. The latch 5033 may be configured to move into and out of the cavity of the battery pack 5006 upon depression of a user actuated latch button 5035 of the battery pack 5006. The latch 5033 may be configured to be received in the catch 5032 of the charger 5000 when the battery pack 5006 is fully engaged with/coupled to the charger 5000 to mechanically couple the battery pack 5006 and the charger 5000. In order to disengage/decouple the battery pack 5006 from the charger 5000, the user actuated latch button 5035 is depressed to release the latch 5033 of the battery pack 5006 from the catch 5032 of the charger 5000. The battery pack 5006 can then be removed from the charger 5000. In another embodiment, the first interface 5010 may include a latch that may be configured to engage with a catch disposed on the battery pack 5006.

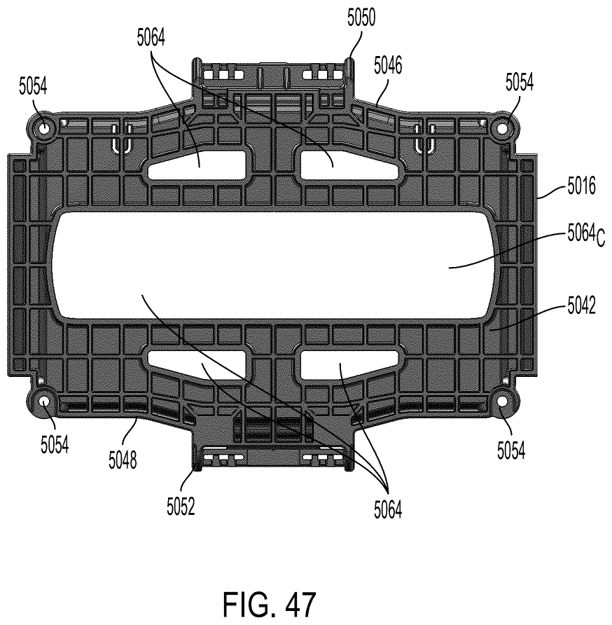

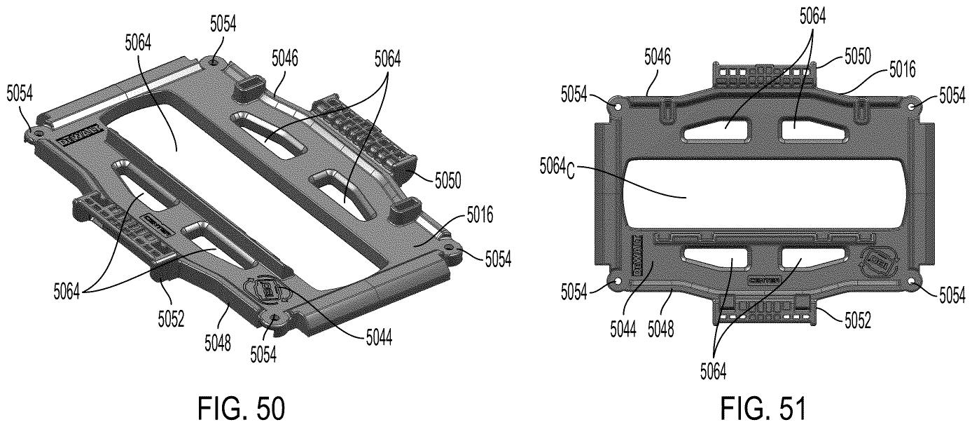

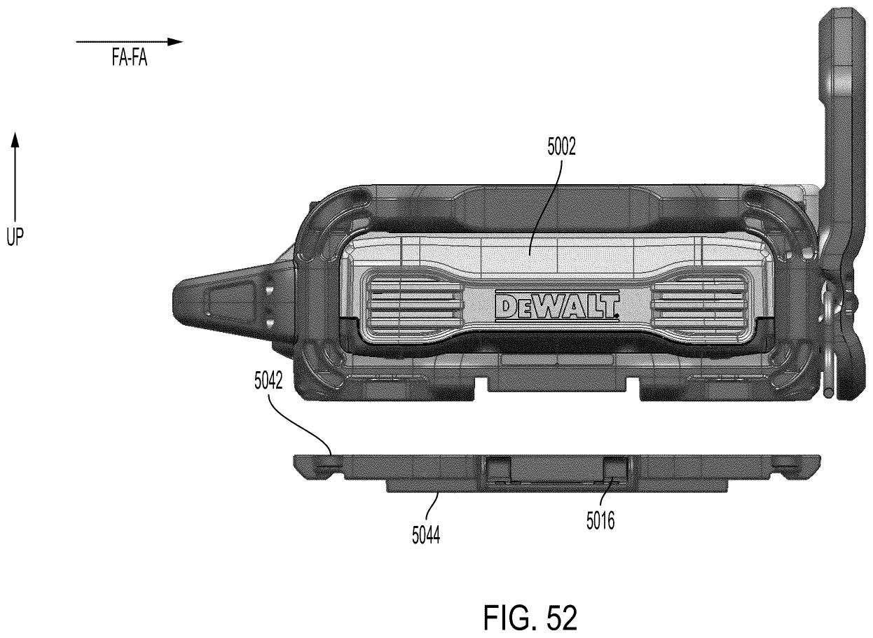

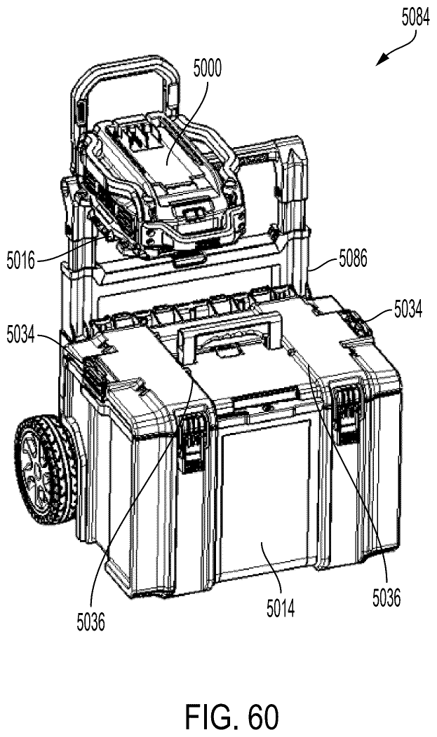

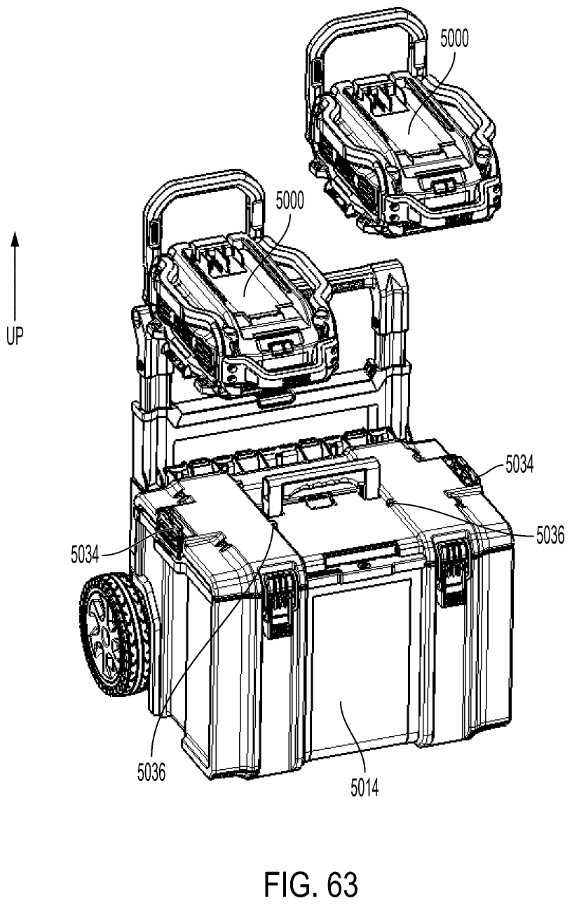

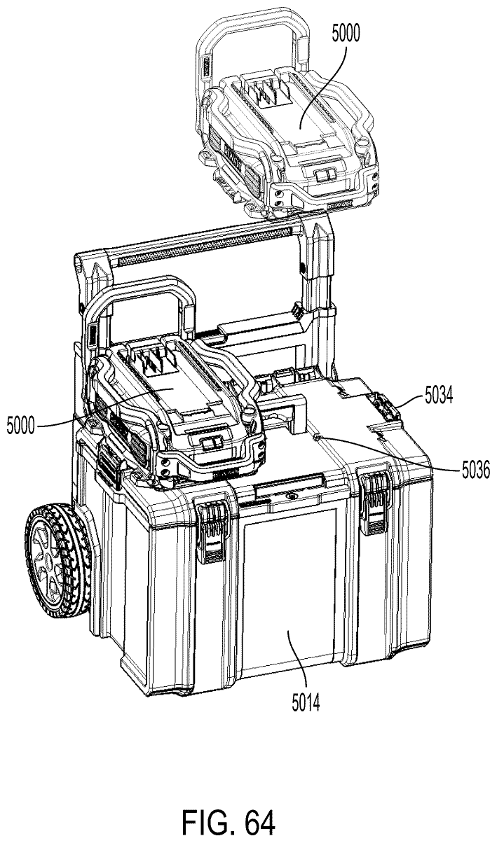

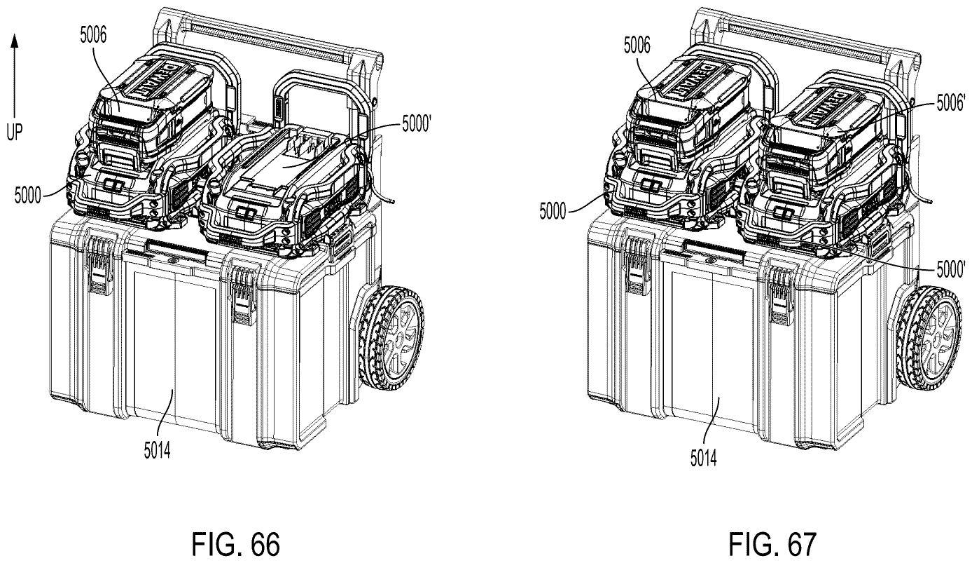

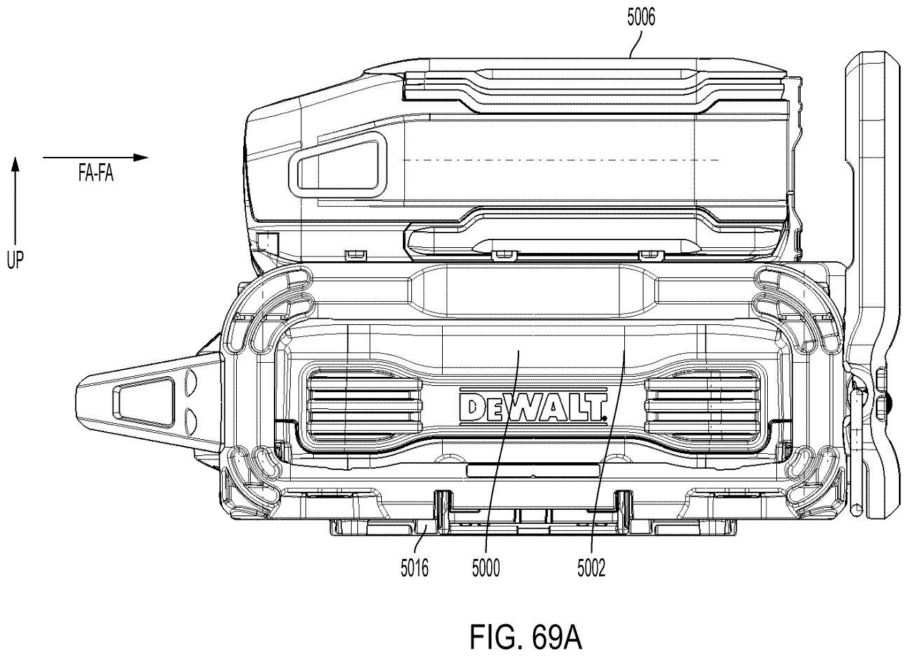

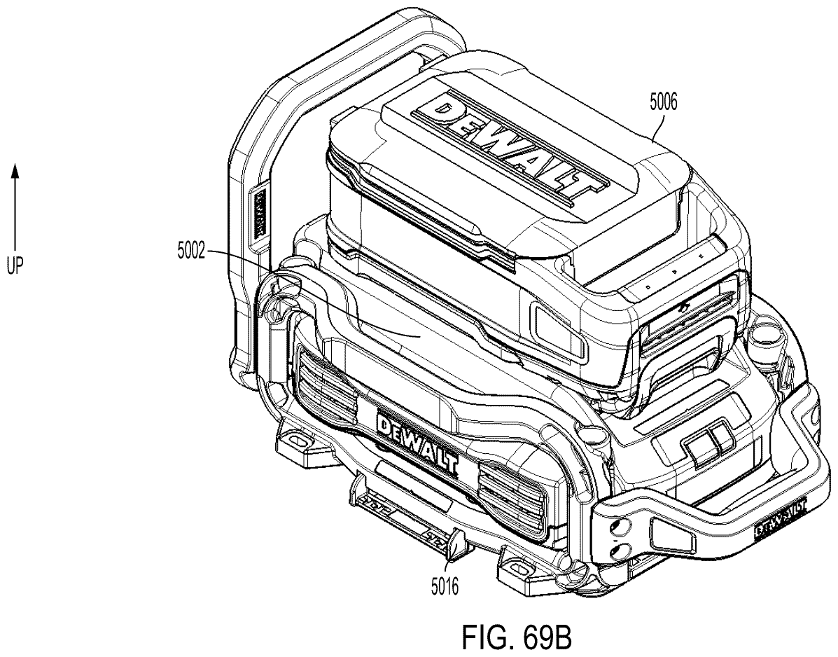

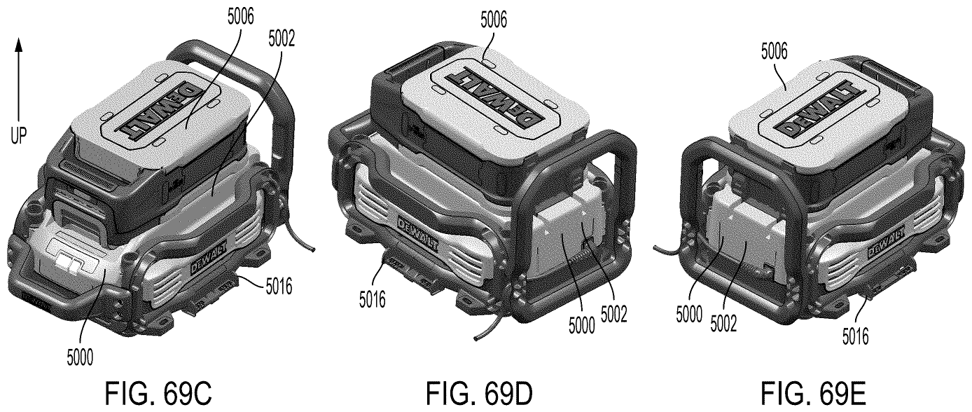

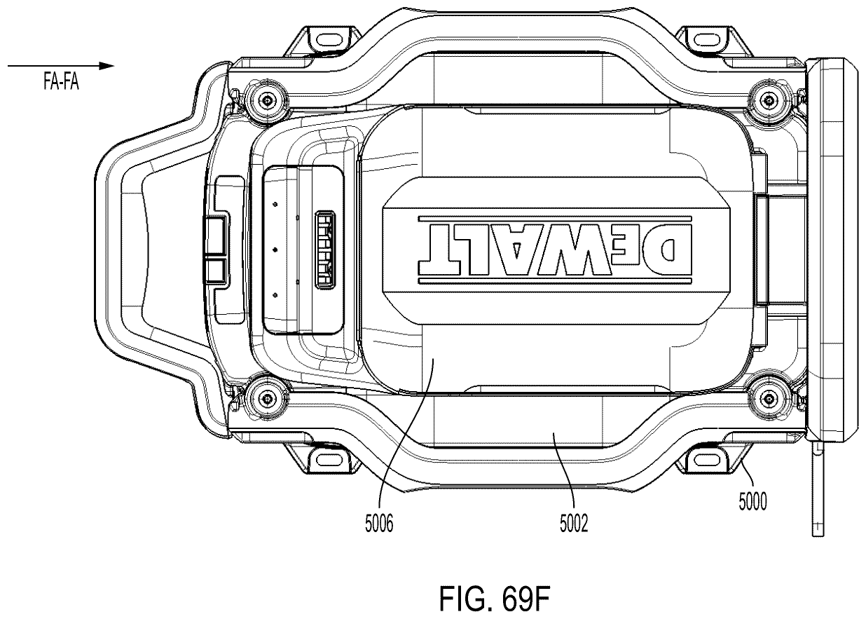

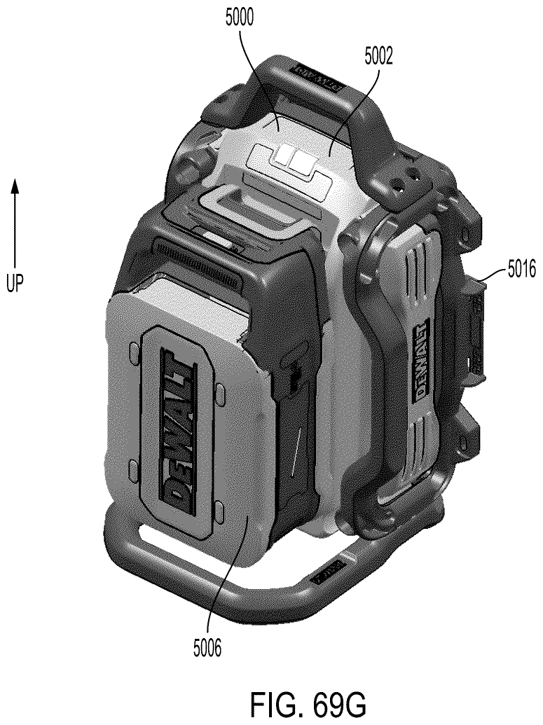

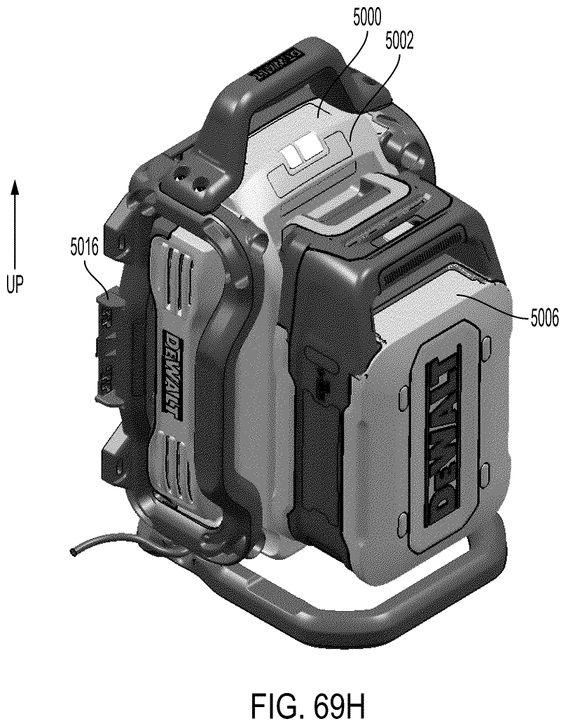

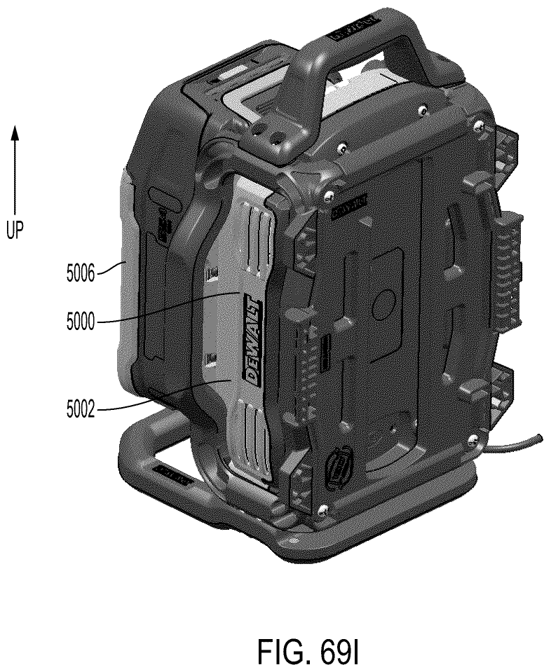

Referring to FIGS. 47-69I, the second side 5008 of the charger 5000 may include a second interface 5012 configured to mount to a storage container 5014. The second interface 5012 may include a coupling plate 5016 for coupling the housing 5002 of the charger 5000 to the storage container 5014.

Referring to FIGS. 47-51, the coupling plate 5016 may include the top 5042, a bottom 5044, a first side 5046 and a second side 5048, opposed to the first side 5046. The coupling plate 5016 may be made of Acrylonitrile Butadiene Styrene (ABS) material. The coupling plate 5016 may be made of a high/hard impact plastic material. The coupling plate 5016 may include a first connection element 5050 disposed on the first side 5046 of the coupling plate 5016. The coupling plate 5016 may include a second connection element 5052 disposed on the second side 5048 of the coupling plate 5016. The first connection element 5050 may also be referred to as plate/coupling plate connection element A. The second connection element 5052 may also be referred to as plate/coupling plate connection element B. The first connection element 5050 and the second connection element 5052 of the coupling plate 5016 may protrude outwardly from their respective sides 5046, 5048 to engage and mate with the corresponding connection elements of the storage container 5014 (as will clear from the discussions described in detail below).

The coupling plate 5016 may include a plurality of cutout regions 5064 that are configured to reduce the weight and amount of material required for the coupling plate 5016. The plurality of cutout regions 5064 may also function as airflow openings 5064 that are configured to allow airflow between the bottom 5020 of the charger 5000 and its surrounding environment. A central cutout region 5064_{C} may be configured to provide access to some components/parts disposed on the bottom 5020 of the charger 5000. The top 5042 of the coupling plate 5016 may include a plurality of longitudinal and transverse reinforcing ribs that intersect to define a plurality of undercut regions/channels between them. The plurality of undercut regions/channels may be configured to reduce the weight and amount of material required for the coupling plate 5016 while the plurality of reinforcing ribs may be configured to provide mechanical strength required by coupling plate 5016.

The top 5042 of the coupling plate 5016 may be configured to be removably connected to the second side 5008 (e.g., bottom 5020) of the charger 5000. In another embodiment, the coupling plate 5016 may be configured to be removably connected to the roll cage. In yet another embodiment, the coupling plate 5016 may be configured to be removably connected to both the roll cage and the charger 5000. The coupling plate 5016 may include fastener openings/holes 5054 in a pattern corresponding to fastener openings/holes 5142 on the bottom 5020 of the charger 5000 and/or fastener openings/holes 5140 on the side roll cage members 5114, 5116 of the charger 5000. Four holes are shown but the number of holes may vary. Mechanical fasteners (e.g., screws, etc.) 5058 may be inserted through the fastener openings/holes 5054, 5142 after they are aligned, for connecting the coupling plate 5016 to the charger 5000.

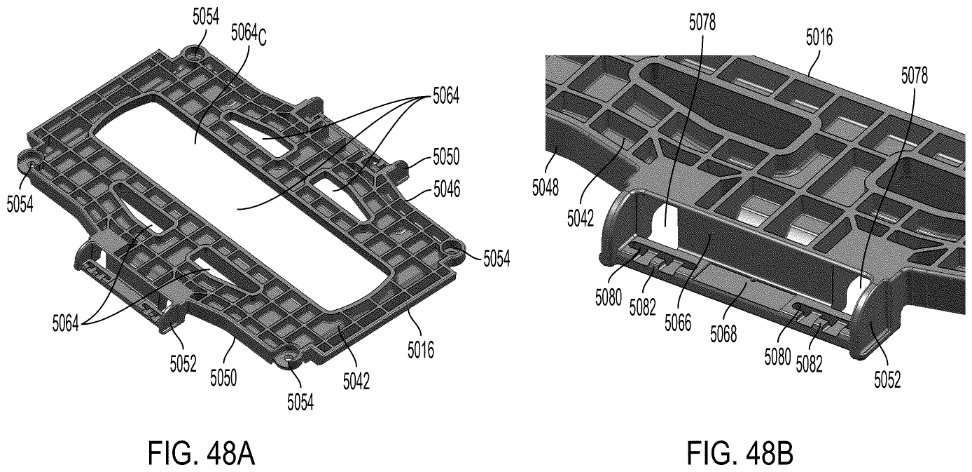

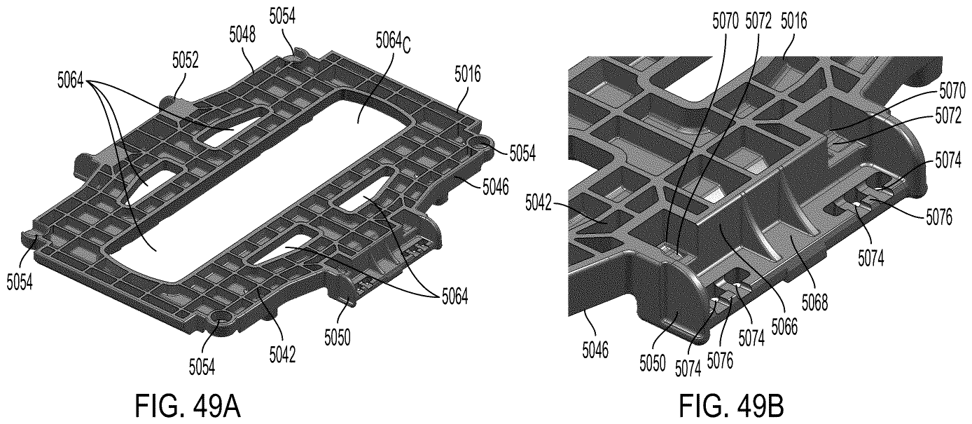

In an example embodiment, the first connection element 5050 and the second connection element 5052 may include an L-shaped configuration or a step shaped configuration having a vertical/first member 5066 and a horizontal/second member 5068. The first connection element 5050 may include a plurality of protrusions, a plurality of openings/recesses, and other interlocking elements (elements which may simply or also engage with each other). As shown in FIG. 49B, the first connection element 5050 may include end recesses 5070 with surfaces 5072 on the first member 5066, and openings 5074 and protrusions 5076 on the second member 5068. The second connection element 5052 may include a plurality of protrusions, a plurality of recesses/openings, and other interlocking elements. As shown in FIG. 48B, the second connection element 5052 includes end openings 5078 on the first member 5066 and recesses/openings 5080 and protrusions 5082 on the second member 5068. These configurations of the first connection element 5050 and the second connection element 5052 are exemplary. The first connection element 5050 and the second connection element 5052 may have any other interlocking configurations as long as the first connection element 5050 and the second connection element 5052 are configured to engage and mate with the corresponding connection elements of the storage container 5014.

The coupling plate 5016 may be configured to be removably attachable to the charger 5000 in either a first orientation or a second orientation. The coupling plate 5016 may be attachable to the second side 5008 (e.g., bottom 5020) of the housing 5002 in the first orientation. In a second orientation, the coupling plate 5016 may be rotated 180° about a second axis SA-SA generally perpendicular to the first axis FA-FA from the first orientation to the second orientation. That is, in the second orientation, the coupling plate second orientation is rotated 180° about a second axis SA-SA generally perpendicular to the first axis FA-FA from the coupling plate first orientation. The coupling plate 5016 may also be rotated 180° about the second axis SA-SA from the second orientation back to the first orientation.

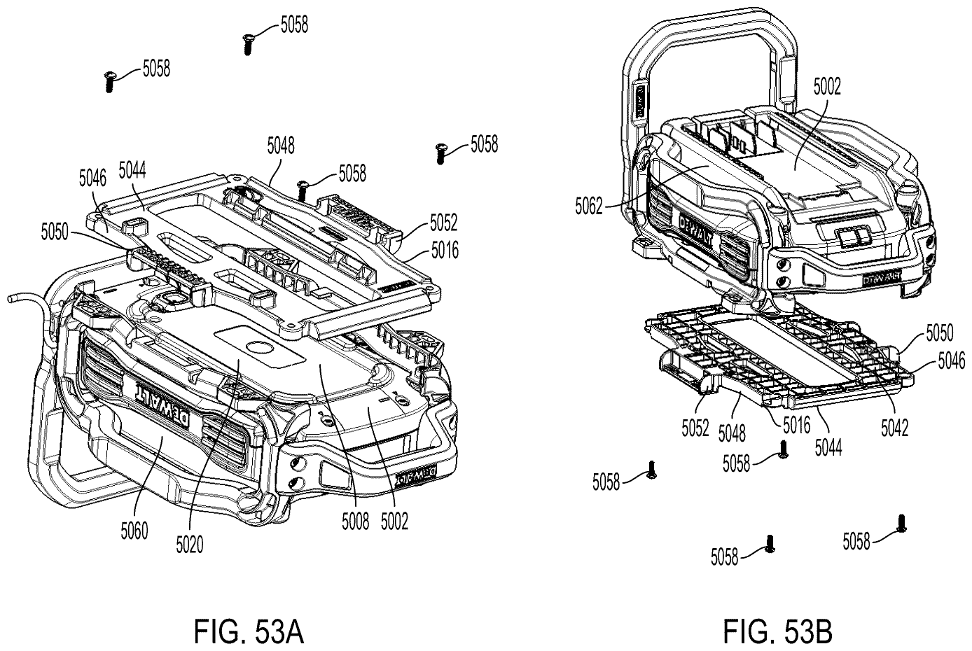

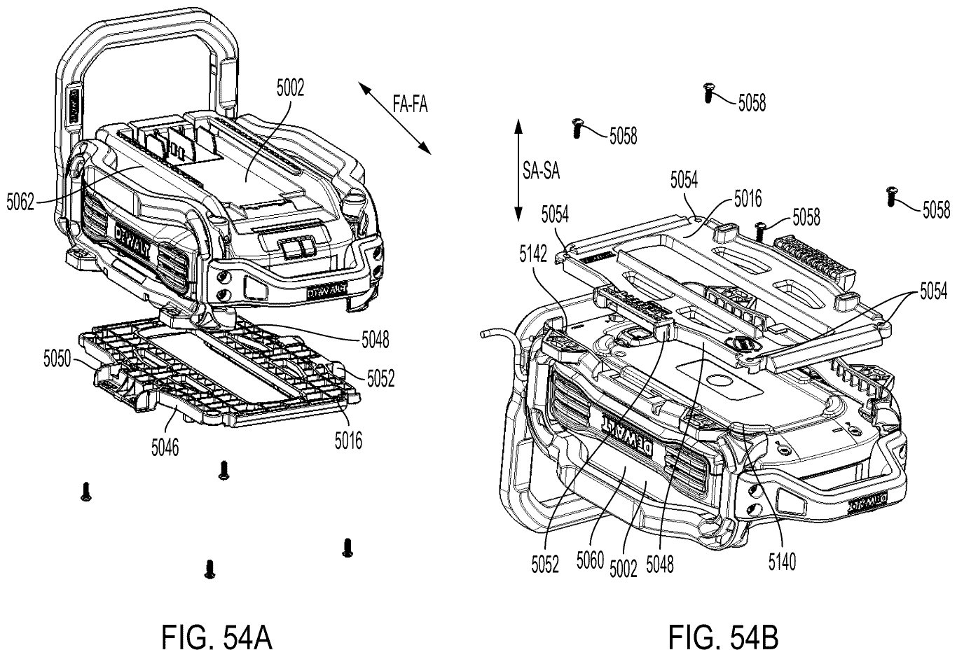

As shown in FIGS. 53A-53B, when the coupling plate 5016 is in the first orientation, the first side 5046 (having the first connection element 5050) of the coupling plate 5016 may be configured to be disposed on the same side as the third side 5060 of the charger 5000 and the second side 5048 (having the second connection element 5052) of the coupling plate 5016 may be configured to be disposed on the same side as the fourth side 5062 of the charger 5000. Alternatively, as shown in FIGS. 54A-54B, when the coupling plate 5016 is in the second orientation, the first side 5046 of the coupling plate 5016 may be configured to be disposed on the same side as the fourth side 5062 of the charger 5000 and the second side 5048 of the coupling plate 5016 may be configured to be disposed on the same side as the third side 5060 of the charger 5000.

The storage container 5014 may include a pair of first connection elements 5034 (5034a, 5034a) and a pair of second connection elements 5036 (5036_{B}, 5036_{B}). The pair of first connection elements 5034 and the pair of second connection elements 5036 may be disposed on a top portion 5038 of the storage container 5014. The first connection elements 5034 may also be referred to as container top connection element A. The second connection elements 5036 may also be referred to as container top connection element B.

The pair of first connection elements 5034 may be disposed at top end portions 5040, 5041 of the storage container 5014. One of the first connection elements 5034 may be disposed at one of the top end portion 5040 and the other of the first connection elements 5034 may be disposed at the other top end portion 5041. The pair of second connection elements 5036 may be disposed between the pair of first connection elements 5034 of the storage container 5014. The pair of second connection elements 5036 may be disposed in a top middle portion of the storage container 5014. The pair of second connection elements 5036 may be disposed between the top end portions 5040, 5041 of the storage container 5014.

The first connection element 5050 of the coupling plate 5016 may have a different configuration than the second connection element 5052 of the coupling plate 5016. As will be clear from the discussions below, the first connection element 5050 of the coupling plate 5016 may be configured to engage and mate with each of the pair of first connection elements 5034 of the storage container 5014. The second connection element 5052 of the coupling plate 5016 may be configured to engage and mate with each of the pair of second connection elements 5036 of the storage container 5014.

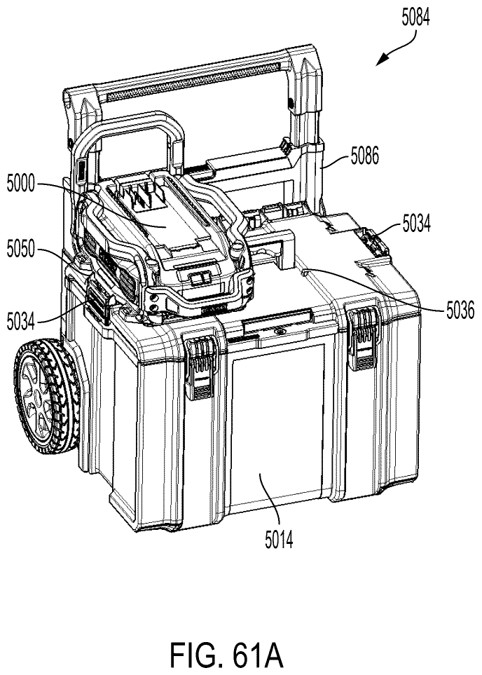

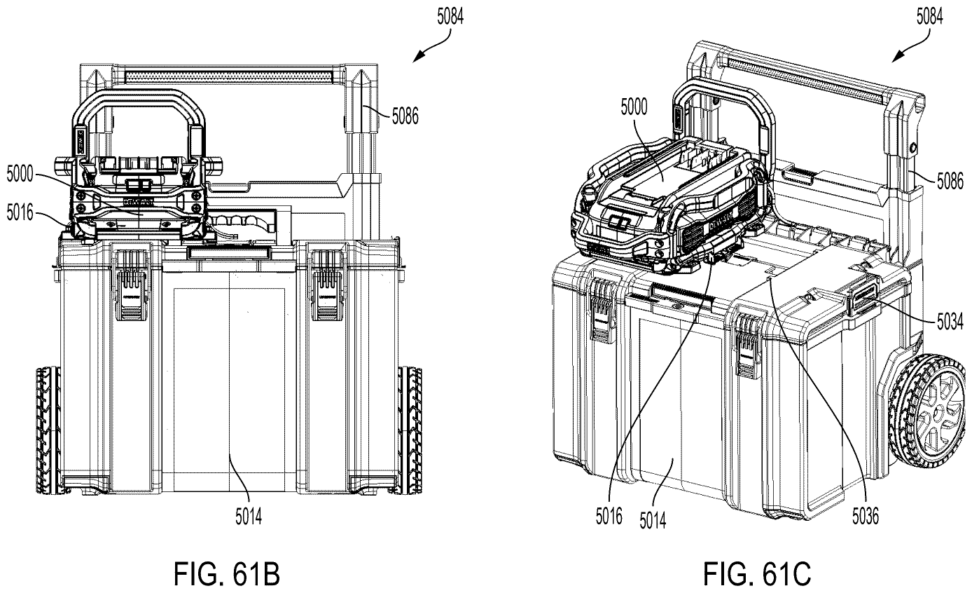

FIGS. 61A-63 show the coupling plate 5016 attached the charger 5000 in the first orientation. The first connection element 5050 of the coupling plate 5016 may be configured to mate with one of the pair of first connection elements 5034 of the storage container 5014 when the coupling plate 5016 is in the first orientation. The second connection element 5052 of the coupling plate 5016 may be configured to mate with one of the pair of second connection elements 5036 of the storage container 5014 when the coupling plate 5016 is in the first orientation.

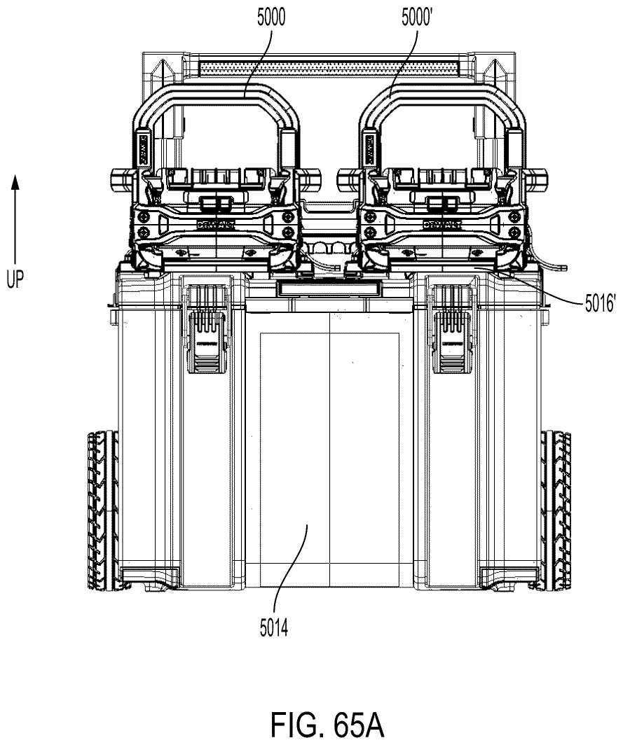

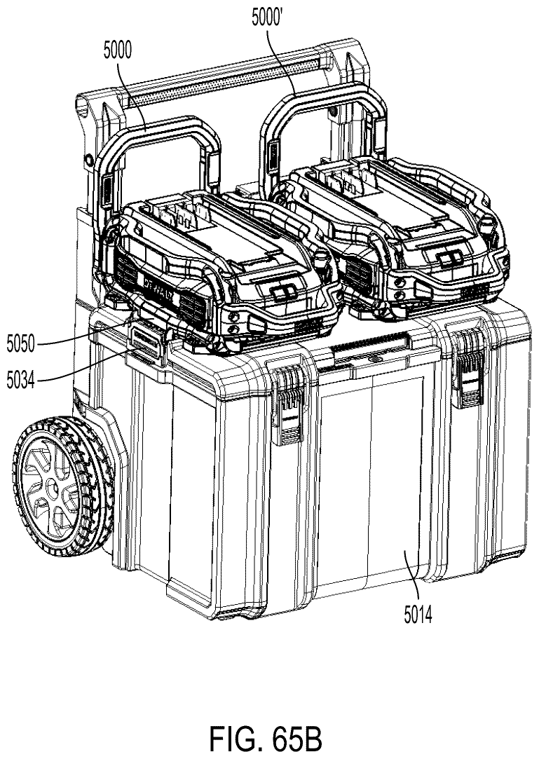

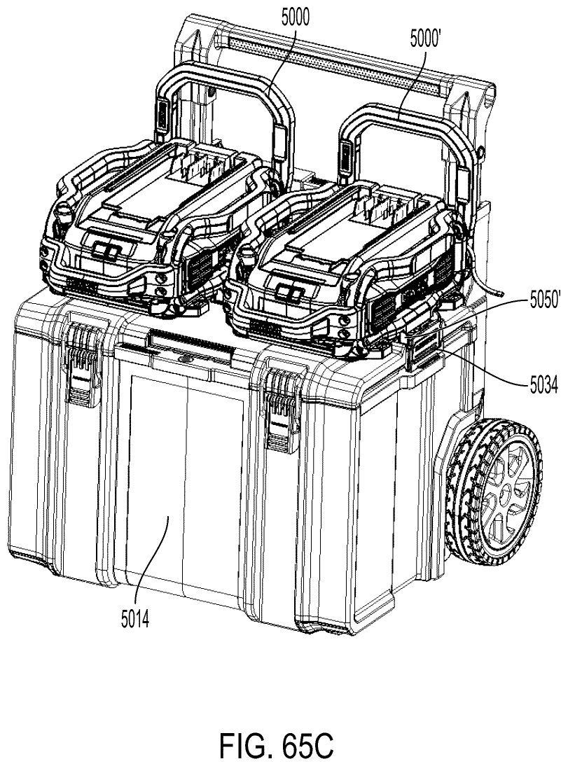

FIGS. 65A-67 show the coupling plate 5016′ attached the charger 5000′ in the second orientation. The first connection element 5050′ of the coupling plate 5016′ may be configured to mate with the other of the pair of first connection elements 5034 of the storage container 5014 when the coupling plate 5016′ is in the second orientation. The second connection element (not shown in the figures but the second connection element of the coupling plate 5016′ is similar to the second connection element 5052 of the coupling plate 5016 as shown and described in detail above) of the coupling plate 5016′ may be configured to mate with the other of the pair of second connection elements 5036 of the storage container 5014 when the coupling plate 5016′ is in the second orientation.

Although the coupling plate 5016′ attached to the charger 5000′ is shown to be in the second orientation in FIGS. 65A-67, a person of ordinary skill in the art would readily appreciate that the coupling plate 5016 of the charger 5000 may be connected to the storage container 5014 in the second orientation (instead of in the first orientation) by (a) disconnecting and removing the charger 5000′, with the coupling plate 5016′ in the second orientation, from the storage container 5014, (b) disconnecting and removing the charger 5000, with the coupling plate 5016 in the first orientation, from the storage container 5014, (c) disconnecting the coupling plate 5016 (in the first orientation) from the charger 5000, (d) rotating the coupling plate 5016 by 180° about the second axis SA-SA generally perpendicular to the first axis FA-FA from the first orientation to the second orientation, (e) connecting the coupling plate 5016 (in the second orientation) to the charger 5000, and (f) connecting the charger 5000, with the coupling plate 5016 in the second orientation, to the storage container 5014. By following these procedures, the charger 5000, with the coupling plate 5016 in the second orientation, may be attached to the storage container 5014, for example, at the same location in which the coupling plate 5016′ attached to the charger 5000′ is shown in FIGS. 65A-67.

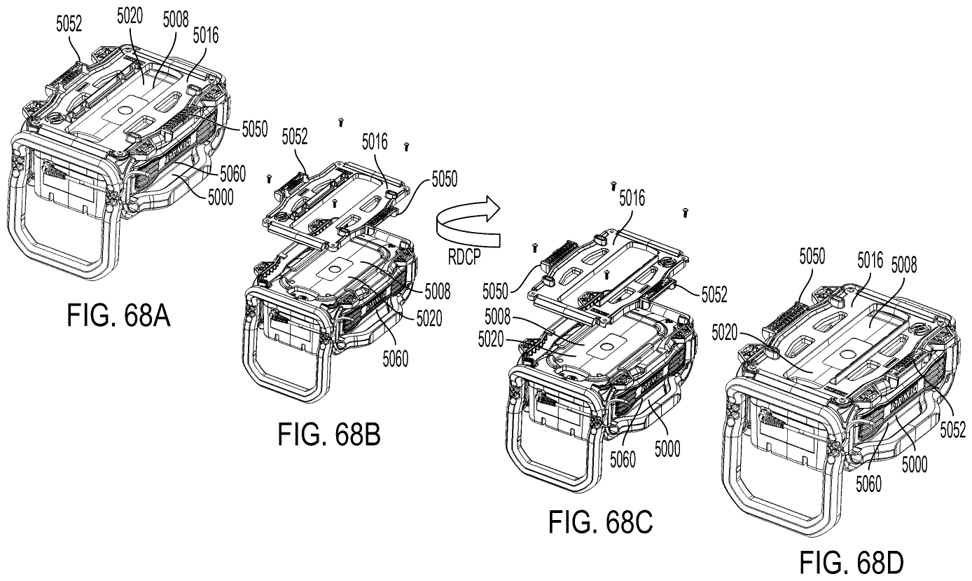

FIGS. 68A-68D show rear, bottom, left-side isometric views with the procedures of moving the coupling plate 5016 between the first orientation and the second orientation. FIG. 68A shows the battery charger 5000 with the coupling plate 5016 attached to the second side 5008 (e.g., bottom 5020) of the housing 5002, where the coupling plate 5016 is in the first orientation. In the first orientation, the first connection element 5050 of the coupling plate 5016 may be disposed on the third side 5060 of the charger 5000, while the second connection element 5052 of the coupling plate 5016 is disposed on the fourth side 5062 of the charger 5000. FIG. 68B shows the coupling plate 5016 in the first orientation disconnected from the battery charger 5000. The coupling plate 5016 is then rotated 180° about the second axis SA-SA (as shown by the arrow RDCP) generally perpendicular to the first axis FA-FA from the first orientation to the second orientation. FIG. 68C shows the coupling plate 5016 in the second orientation (disconnected from the battery charger 5000) and ready to be connected to the battery charger 5000. In the second orientation, the second connection element 5052 of the coupling plate 5016 may be disposed on the third side 5060 of the charger 5000, while the first connection element 5050 of the coupling plate is disposed on the fourth side 5062 of the charger 5000. FIG. 68D shows the battery charger 5000 with the coupling plate 5016 attached to the second side 5008 (e.g., bottom 5020) of the housing 5002, where the coupling plate 5016 is in the second orientation.

Similar procedures may be followed to move the coupling plate 5016 from the second orientation to the first orientation. In the second orientation, the second connection element 5052 of the coupling plate 5016 may be disposed on the third side 5060 of the charger 5000, while the first connection element 5050 of the coupling plate 5016 is disposed on the fourth side 5062 of the charger 5000. The coupling plate 5016 in the second orientation may be disconnected from the battery charger 5000. The coupling plate 5016 is then rotated 180° about the second axis SA-SA (as shown by the arrow RDCP) generally perpendicular to the first axis FA-FA from the second orientation to the first orientation. In the first orientation, the first connection element 5050 of the coupling plate 5016 may be disposed on the third side 5060 of the charger 5000, while the second connection element 5052 of the coupling plate 5016 is disposed on the fourth side 5062 of the charger 5000. The battery charger 5000 with the coupling plate 5016 attached to the second side 5008 (e.g., bottom 5020) of the housing 5002, where the coupling plate 5016 is in the first orientation.

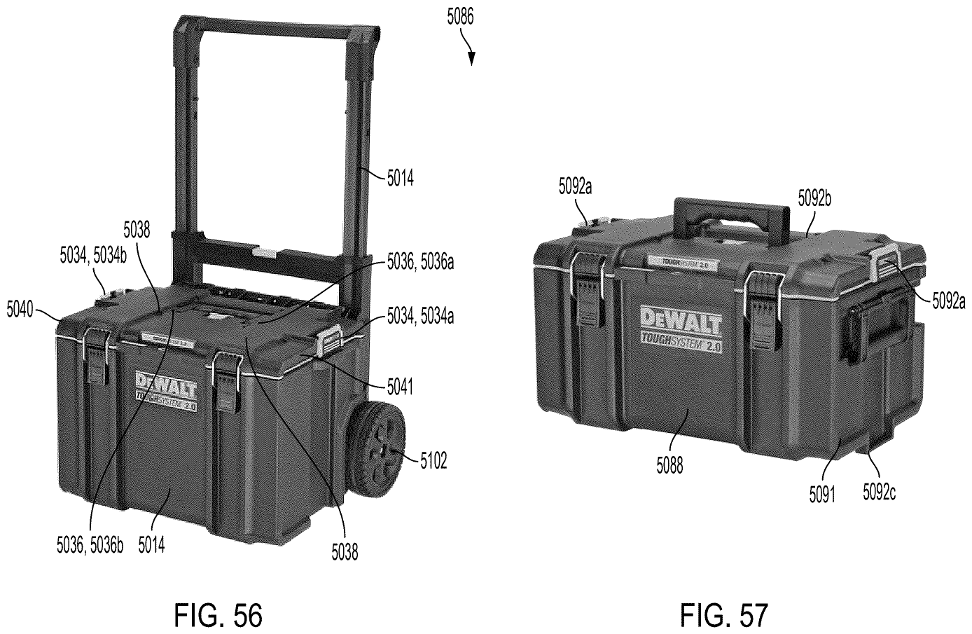

Referring to FIGS. 56-62B, the present patent application includes a battery pack charger system 5084. The battery pack charger system 5084 may include the battery pack charger 5000, a storage system 5086, and the coupling plate 5016. As shown in FIGS. 56-59, the storage system 5084 may include a plurality of storage containers 5014 and 5088 and an attachment system 5090. The attachment system 5090 may include a first set of components 5034, 5036 incorporated into the first storage container 5014 of the plurality of storage containers 5014 and 5088 and a second set of components 5092a, 5092b, 5092c incorporated into a second storage container 5088 of the plurality of storage containers. The second set of components 5092a, 5092b, 5092c of the second storage container 5088 may include a plurality of connecting elements 5092a, 5092b disposed on the top portion of the second storage container 5088 and a plurality of connecting elements 5092c disposed on the bottom portion of the second storage container 5088. The first set of components 5034 of the first storage container 5014 may be configured to mate with the second set of components 5092c of the second storage container 5088 to affix the first storage container 5014 to the second storage container 5088.

Referring to FIG. 56, the first set of components 5034, 5036 of the first storage container 5014 may include a pair of first connection elements 5034a, 5034b and a pair of second connection elements 5036a, 5036b. The pair of first connection elements 5034a, 5034b and the pair of second connection elements 5036a, 5036b may be disposed on the top portion 5038 of the storage container 5014. The pair of first connection elements 5034a, 5034b may be disposed at the end portions 5040, 5041 of the storage container 5014. The pair of second connection elements 5036a, 5036b are disposed between the pair of first connection elements 5034a, 5034b of the storage container 5014.

Referring to FIG. 57, the second set of components 5092a, 5092b, 5092c of the second storage container 5088 may include a pair of first connection elements 5092c. The pair of first connection elements 5092c may be disposed on a bottom portion 5091 of the second storage container 5088. The connection elements 5092a, 5092b of the second storage container 5088 may be similar (in construction and configuration) to and may be disposed at same locations as the connection elements 5034, 5036 of the first storage container 5014.

The pair of first connection elements 5034 of the first storage container 5014 are configured to engage and mate with the pair of first connection elements 5092c (e.g., on the bottom portion 5091) of the second storage container 5088 to affix the first storage container 5014 to the second storage container 5088.

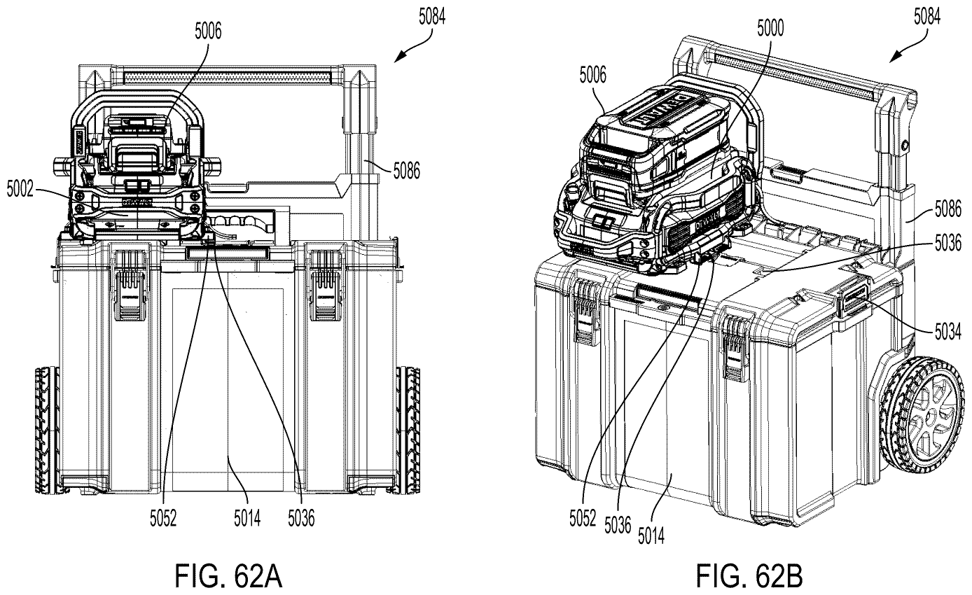

The coupling plate 5016 may include a third set of components 5050, 5052 configured to mate with a first subset 5034a, 5036a, respectively, of the first set of components 5034, 5036 of the first storage container 5014 for affixing the charger 5000 to the first storage container 5014 at a first location and with a second subset 5034b, 5036b, respectively, of the first set of components 5034, 5036 of the first storage container 5014 for affixing the charger 5000 to the first storage container 5014 at a second location. The second location is adjacent to the first location. In FIGS. 61A to 62B, the charger 5000 is in the first location. In FIGS. 65 to 67, the charger 5000 is in the first location and the charger 5000′ is in the second location.

As discussed in detail above, the first set of components 5034, 5036 may include the pair of first connection elements 5034a, 5034b and the pair of second connection elements 5036a, 5036b. The first subset 5034a, 5036a of the first set of components 5034, 5036 of the first storage container 5014 may include one of the pair 5034a of first connection elements 5034 and one of the pair 5036a of second connection elements 5036. The second subset of the first set of components 5034, 5036 of the first storage container 5014 may include the other of the pair 5034b of first connection elements 5034 and the other of the pair 5036b of second connection elements 5036.

The third set of components 5050, 5052 of the coupling plate 5016 includes a first connection element 5050 disposed on the first side 5046 of the coupling plate 5016 and a second connection element 5052 disposed on the second side 5048 of the coupling plate 5016.

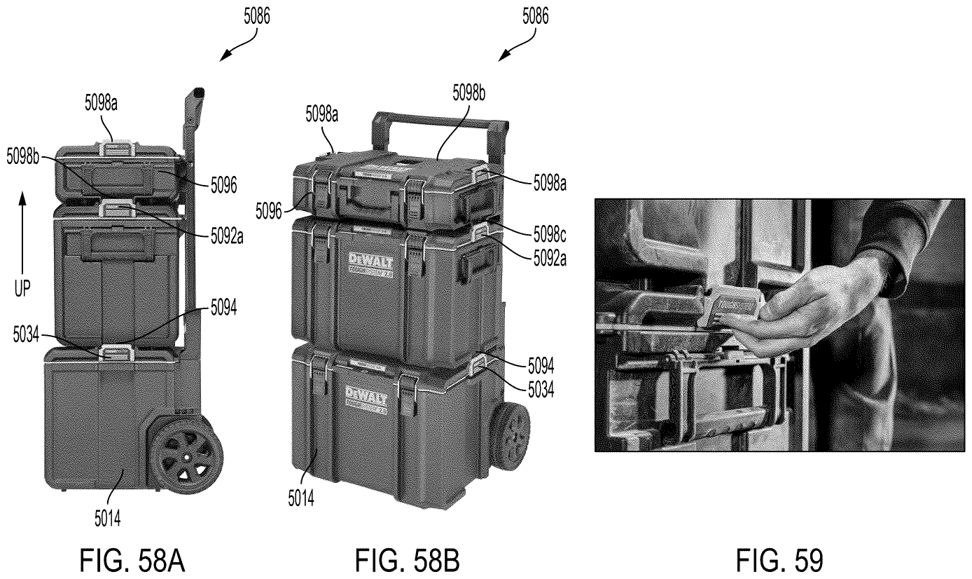

Referring to FIGS. 58A-58B, the storage system 5086 may include a third storage container 5096. The third storage container 5096 may include a fourth set of components 5098a, 5098b, 5098c. One component 5098c of the fourth set of components 5098a, 5098b, 5098c of the third storage container 5096 may be configured to mate with the one component 5092a of the second set of components 5092 of the second storage container 5088 to affix the third storage container 5096 to the second storage container 5088. One component 5098c of the fourth set of components 5098a, 5098b, 5098c of the third storage container 5096 may be configured to mate with the One component 5034a of the first set of components 5034 of the first storage container 5014 to affix the first storage container 5014 to the third storage container 5096.

The first, the second and the third storage containers 5014, 5088, 5096 may have different sizes and/or configurations. The third storage container 5096 may be smaller than the second storage container 5088, which may be smaller than the first storage container 5014. The first, the second and the third storage containers 5014, 5088, 5096 may have the same size and/or configuration. The third storage container 5096 may be the same size as the second storage container 5088 and they both may be smaller than the first storage container 5014.

The first storage container 5014 may include a wheeled storage container. The first storage container 5014 may include wheels 5102 disposed toward a rear, lower/bottom portion thereof and a handle 5104 for rolling transport of the first storage container 5014. The wheels 5102 and the handle 5104 may be configured for rolling transport the assembly in a backwards tilted configuration. The handle 5104 may have telescopic configuration. The handle 5104 may be movable between a range of positions having an upper limit and a lower limit. Support legs of the handle 5104 may be configured to telescopically receive extension legs of the handle 5104 to enable such lowering and extension. The second and the third storage containers 5088, 5096 may include a non-wheeled storage containers. Each of the first, the second and the third storage containers 5014, 5088, 5096 may also include a base container having an upper opening into an interior storage space, and a top cover. The top cover may be pivotable and may be arranged to selectively permit or prevent access to the storage space of the base container.

The second and the third storage containers 5088, 5096 may include top connection elements at the top portion and bottom connection elements at the bottom portion thereof. The bottom connection elements may also be referred to as container bottom connection element, and the top connection elements may also be referred to as container top connection element. When the third storage container 5096 is positioned on top of the second storage container 5088, the top connection elements at the top portion of the second storage container 5088 are configured to connect to the bottom connection elements at the bottom portion of the third storage container 5096 to connect the storage containers 5088, 5096. Like the first storage container 5014 (with the container connection elements 5036), the second and the third storage containers 5088, 5096 may include top, middle container connections elements (i.e., connection elements that are disposed in the top portion of the storage container and between the end connections elements) that are configure to couple with the plate connection elements so as to connect the coupling plate 5016 (with the charger 5000 attached thereto) to either the second storage container 5088 or to the third storage container 5096.

The first connection element 5050 of the coupling plate 5016 may be configured to mate with one of the pair 5034a of the first connection elements 5034 of the first storage container 5014 when the battery pack charger 5000 is affixed to the first storage container 5014 at the first location. The second connection element 5052 of the coupling plate 5016 is configured to mate with one of the pair 5036a of the second connection elements 5036 of the first storage container 5014 when the battery pack charger 5000 is affixed to the first storage container 5014 at the first location.

The first connection element 5050 of the coupling plate 5016 may be configured to mate with the other of the pair 5034b of the first connection elements 5034 of the first storage container 5014 when the battery pack charger 5000 is affixed to the first storage container 5014 at the second location. The second connection element 5052 of the coupling plate 5016 is configured to mate with the other of the pair 5036b of the second connection elements 5036 of the first storage container 5014 when the battery pack charger 5000 is affixed to the first storage container 5014 at the second location.

The battery pack charger 5000 is a first battery pack charger and the coupling plate 5016 is a first coupling plate. The first connection element 5050 of the first coupling plate 5016 may be configured to mate with one of the pair 5034a of the first connection elements 5034 of the first storage container 5014 and the second connection element 5052 of the first coupling plate 5016 may be configured to mate with one of the pair 5036a of the second connection elements 5036 of the first storage container 5014 when the first battery pack charger 5000 and its associated coupling plate 5016 is affixed to the first storage container 5014 at the first location. The first connection element (not shown in the figures but the first connection element of the coupling plate 5016′ is similar to the first connection element 5050 of the coupling plate 5016 as shown and described in detail above) of the second coupling plate 5016′ is configured to mate with the other of the pair 5034b of first connection elements 5034 of the first storage container 5014 and a second connection element (not shown in the figures but the second connection element of the coupling plate 5016′ is similar to the second connection element 5052 of the coupling plate 5016 as shown and described in detail above) of the second coupling plate 5016′ is configured to mate with the other of the pair 5036b of the second connection elements 5036 of the first storage container 5014 when the second battery pack charger 5000′ and its associated coupling plate 5016′ is affixed to the first storage container 5014 at the second location.

The first coupling plate 5016 and the second coupling plate 5016′ are configured to be interchangeable with each other such that (1) the first coupling plate 5016 is configured to be used with either the first battery pack charger 5000 or the second battery pack charger 5000′ to affix the first battery pack charger 5000 or second battery pack charger 5000′ to the first storage container 5014 either at the first location or at the second location, and (2) the second coupling plate 5016′ is configured to be used with either the first battery pack charger 5000 or the second battery pack charger 5000′ to affix the first battery pack charger 5000 or the second battery pack charger 5000′ to the first storage container 5014 either at the first location or at the second location.

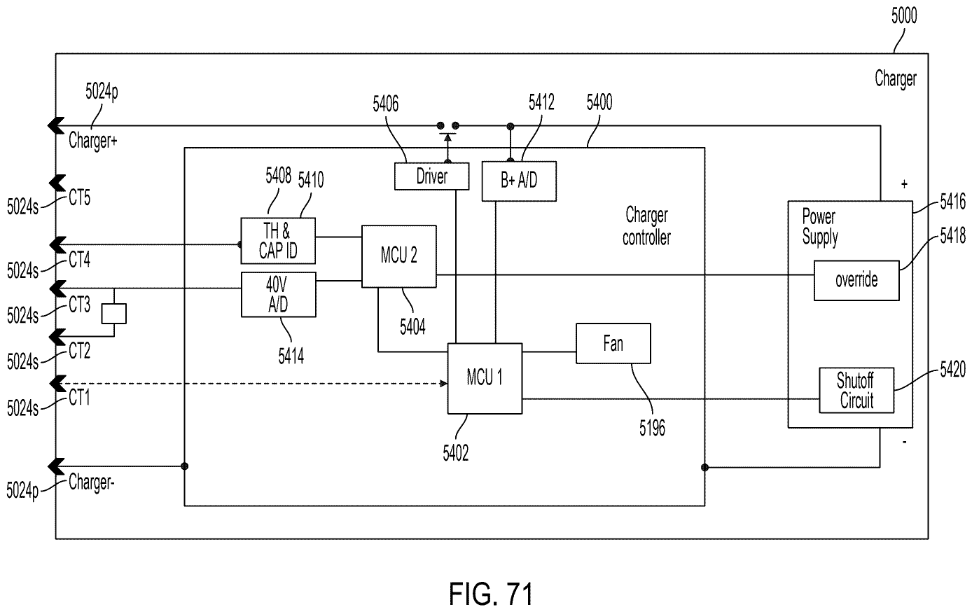

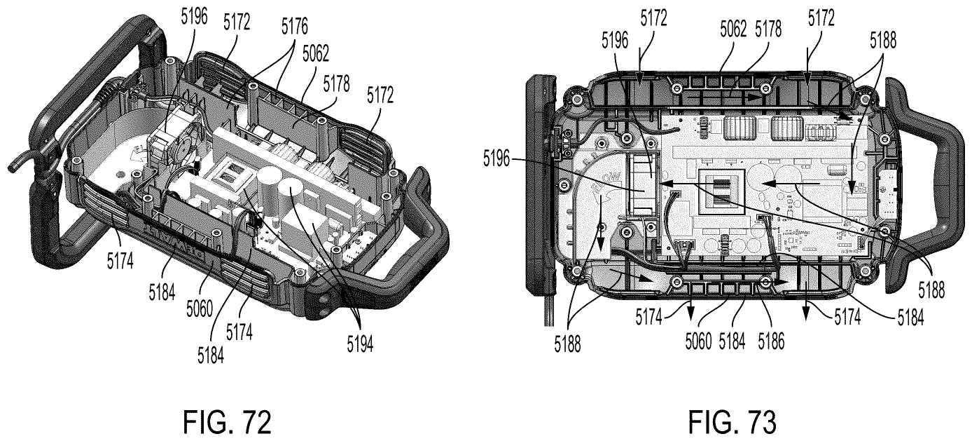

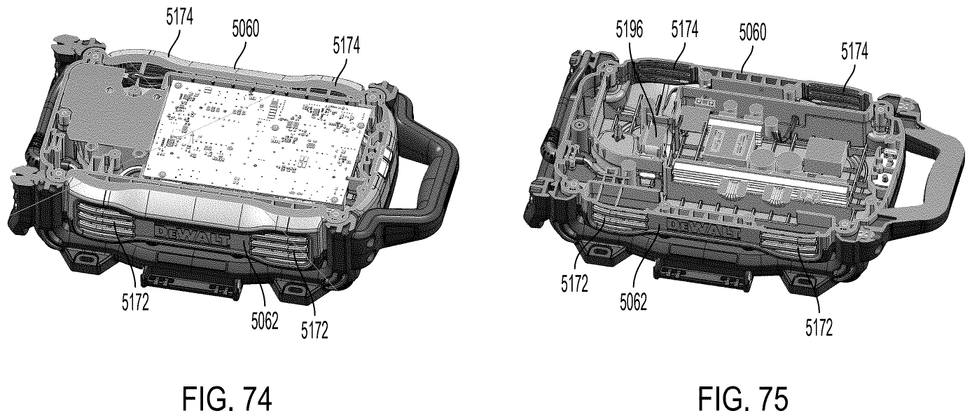

The charger 5000 may have a charger electronic control unit as shown in FIG. 71. The charger electronic control unit may be embodied in hardware or software as a digital microcontroller, a microprocessor or an analog circuit, a digital signal processor or by one or more digital ICs such as application specific integrated circuits (ASICs), for example. The charger electronic control unit may include various types of memory that may execute one or more software or firmware programs. Example memory may include RAM, FLASH and EEPROM. As an example, RAM may be used to store program variables during run time. As an example, FLASH memory may be used to store program code and calibration values. EEPROM may also be provided to store calibration values, data logging information, error codes, etc. The charger electronic control unit may be embodied as a microcontroller and referred to as a “controller” for purposes of brevity.

The charger electronic control unit in FIG. 71 may include a charger controller 5400. The charger controller may include two microcontrollers or microcontroller units 5402, 5404 (MCU1 and MCU2), a fan 5196, a driver 5406, a TH/thermal/temperature monitoring/sensing unit 5408, an ID/battery pack identification unit 5410, a B+ (charging) analog to digital (A/D) converter 5412, a 40V analog to digital (A/D) converter 5414, etc. The temperature monitoring/sensing device may include a negative temperature co-efficient (NTC) resistor, or thermistor, R_{T}. The temperature sensing device/unit may be configured for monitoring of the battery pack temperature. A person of ordinary skill in the art would recognize that other components, such as capacitors, etc., or circuits can be used to provide a signal representative of the battery pack temperature. The charger electronic control unit in FIG. 71 may also include power supply module 5416 with an override circuit 5418 and a shutoff circuit 5420. The charger electronic control unit in FIG. 71 may also include charger+ terminal 5024_{P}, communications/signal terminals 5024_{S} (CT1, CT2, CT3, CT4, CT5) and charger− terminal 5024_{P}.

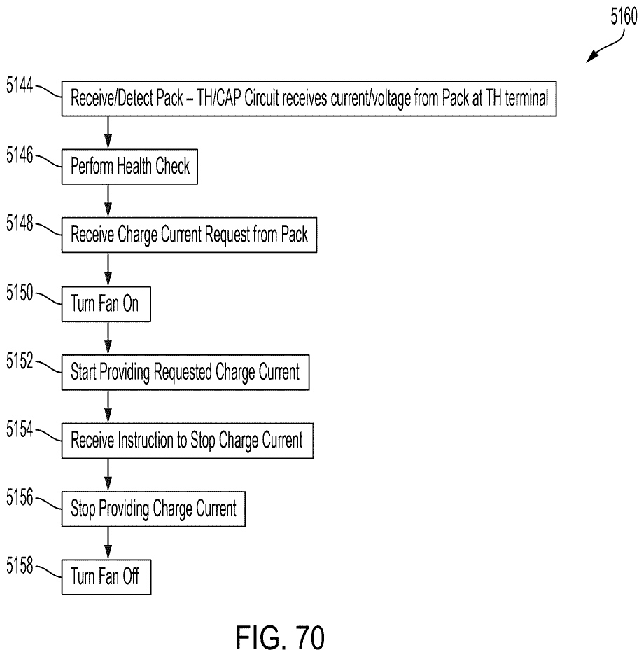

FIG. 70 shows a method 5160 of operation of the charger 5000. For example, at step 5144, a controller of the charger 5000 may be configured to detect whether the battery pack 5006 is received by the charger 5000 at the first interface 5010. The TH/CAP circuit, in FIG. 71, may be configured to receive current or voltage from the battery pack 5006 at TH terminal to make this determination. At step 5146, the controller of the charger 5000 may be configured to perform health check of the received battery pack 5006. At step 5148, the controller of the charger 5000 may be configured to receive a charge current request from the battery pack 5006. At step 5150, the controller of the charger 5000 may be configured to turn on the fan. At step 5152, the controller of the charger 5000 may be configured to start providing the requested current to the battery pack 5006. At step 5154, the controller of the charger 5000 may be configured to receive instructions to stop providing current. At step 5156, the controller of the charger 5000 may be configured to stop providing the current to the battery pack 5006. At step 5158, the controller of the charger 5000 may be configured to turn the fan off.

The charger 5000 may include a set of inlet vents 5172 on the first side 5062 of the housing 5002, a set of outlet vents 5174 on the second side 5060 of the housing 5002, a first baffle 5176 within the housing 5002 defining a first airflow pathway 5178, a second baffle 5184 within the housing 5002 defining a second airflow pathway 5186. The first baffle 5176 and the second baffle 5184 define a third airflow pathway 5188. The inlet airflow direction is shown with an arrow IAFD and the outlet airflow direction is sown with an arrow OAFD.

The set of inlet vents 5172 may include a pair of inlet vents 5172. The set of inlet vents 5174 is configured to permit air from an ambient environment to enter the housing 5002 as intake air. The inlet vents may also be referred to as intake vents.

The set of outlet vents 5174 may include a pair of outlet vents 5174. The outlet vents may also be referred to as exhaust vents. The airflow pathways may also be referred to as air/airflow passageways.

The charger 5000 may include a plurality of power supply charging components 5194 centrally positioned within the housing 5002 along the third airflow pathway 5188, and a fan 5196 within the housing 5002. The fan 5196 may be configured to draw air into the housing 5002 through the set of inlet vents 5172 along the first airflow pathway 5178, along the third airflow pathway 5188 past the plurality of power supply charging components 5194, through the fan 5196, along the second airflow pathway 5186 and forcing the air out of the housing 5002 through the set of outlet vents 5174. The fan 5196 may be configured to draw air from an exterior of the housing 5002 through the inlet vents 5172 into and through the airflow pathways 5178, 5186, 5188 and expel the air to the exterior of the housing 5002 through the outlet vents 5714. The fan 5196 may be configured for drawing air into the housing 5002 of the charger 5000 that is used to produce an air flow for cooling an electronics module having electronic controls for operation of the charger 5000.

The first airflow pathway 5178, the second airflow pathway 5186, and the third airflow pathway 5188 form an S-shaped airflow pathway. The fan 5196 is positioned upstream of the first airflow pathway 5178 and the third airflow pathway 5188. The second airflow pathway 5186 is disposed downstream of the fan 5196.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by a person of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A battery pack charger, comprising:
a housing, the housing including a first side and a second side, opposed to the first side, the first side including a first interface configured to receive a battery pack along a first axis and the second side including a second interface configured to mount to a storage container, the second interface including a coupling plate for coupling the housing to the storage container, the coupling plate attachable to the second side of the housing in a first orientation and in a second orientation, the coupling plate second orientation rotated 180° about a second axis generally perpendicular to the first axis from the coupling plate first orientation.

2. The battery pack charger of claim 1, wherein the first side includes a top of the battery pack charger, wherein the second side includes a bottom of the battery pack charger, and wherein the first axis includes a horizontal insertion direction of the battery pack.

3. The battery pack charger of claim 2, wherein the first interface of the battery pack charger is configured to facilitate interconnections with the battery pack and comprises a set of terminals configured for engagement along the first axis to the battery pack and configured to provide an electrical interconnection with the battery pack; and a rail interface portion configured for engagement along the first axis to the battery pack and configured to provide a physical interconnection with the battery pack.

4. The battery pack charger of claim 3, wherein the storage container comprises a pair of first connection elements and a pair of second connection elements, wherein the pair of first connection elements and the pair of second connection elements are disposed on a top portion of the storage container, wherein the pair of first connection elements are disposed at end portions of the storage container, and wherein the pair of second connection elements are disposed between the pair of first connection elements of the storage container.

5. The battery pack charger of claim 4, wherein the coupling plate comprises:
a top, a bottom, a first side and a second side, opposed to the first side;
a first connection element disposed on the first side of the coupling plate; and
a second connection element disposed on the second side of the coupling plate.

6. The battery pack charger of claim 5, wherein the first connection element of the coupling plate is configured to mate with one of the pair of first connection elements of the storage container when the coupling plate is in the first orientation, and
wherein the first connection element of the coupling plate is configured to mate with the other of the pair of first connection elements of the storage container when the coupling plate is in the second orientation.

7. The battery pack charger of claim 6, wherein the second connection element of the coupling plate is configured to mate with one of the pair of second connection elements of the storage container when the coupling plate in the first orientation, and
wherein the second connection element of the coupling plate is configured to mate with the other of the pair of second connection elements of the storage container when the coupling plate in the second orientation.

8. The battery pack charger of claim 7, wherein the housing comprises a third side and a fourth side, opposed to the third side,
wherein the top of the coupling plate is configured to be removably connected to the battery pack charger on the second side of the battery pack charger,
wherein the first side of the coupling plate is configured to be disposed on the third side of the battery pack charger and the second side of the coupling plate is configured to be disposed on the fourth side of the battery pack charger, when the coupling plate is in the first orientation, and
wherein the first side of the coupling plate is configured to be disposed on the fourth side of the battery pack charger and the second side of the coupling plate is configured to be disposed on the third side of the battery pack charger, when the coupling plate is attached in the second orientation.

9. The battery pack charger of claim 8, wherein the first connection element of the coupling plate has a different configuration than the second connection element of the coupling plate.

10. The battery pack charger of claim 9, wherein the first connection element of the coupling plate is configured to engage and mate with each of the pair of first connection elements of the storage container.

11. The battery pack charger of claim 10, wherein the second connection element of the coupling plate is configured to engage and mate with each of the pair of second connection elements of the storage container.

12. A battery pack charger, comprising:
a housing, and
a roll cage affixed to the housing, the roll cage including at least one handle to enable carrying the battery pack charger with a battery pack insertion direction being vertical and at least one handle to enable carrying the battery pack charger with the battery pack insertion direction being horizontal.

13. The battery pack charger of claim 12, wherein, when the battery pack charger is disposed such that the battery pack insertion direction is horizontal, the housing of the battery pack charger includes a top, a bottom, a front, a back, and a pair of opposing sides,
wherein the at least one handle to enable carrying the battery pack charger with the battery pack insertion direction being vertical includes a first handle attached to the front of the housing.

14. The battery pack charger of claim 12, wherein the first handle is configured to extend outwardly from a front wall of the battery pack charger, when the battery pack charger is disposed such that the battery pack insertion direction is horizontal.

15. The battery pack charger of claim 14, wherein the roll cage includes a roll cage frame defined by substantially tubular members,
wherein the roll cage frame includes a pair of opposing side frame portions that are spaced from and substantially parallel to each other, and
wherein the roll cage frame also includes a rear frame portion that is disposed in a plane that is perpendicular to planes of the pair of opposing side frame portions.

16. The battery pack charger of claim 15, wherein the at least one handle to enable carrying the battery pack charger with the battery pack insertion direction being horizontal includes a pair of side handles attached to the pair of opposing sides of the housing.

17. A battery pack charger, comprising:
a housing;
a roll cage affixed to the housing, the roll cage providing stable support for a first orientation in which the battery pack insertion direction is generally horizontal and a second orientation in which the battery pack insertion direction is generally vertical.

18. The battery pack charger of claim 17, wherein the roll cage includes a roll cage frame defined by substantially tubular members,
wherein the roll cage frame includes a pair of opposing side frame portions that are spaced from and substantially parallel to each other, and
wherein the roll cage frame also includes a rear frame portion that is disposed in a plane that is perpendicular to planes of the pair of opposing side frame portions.

19. The battery pack charger of claim 18, wherein the pair of opposing side frame portions of the roll cage are configured to provide stable support for the first orientation in which the battery pack insertion direction is horizontal.

20. The battery pack charger of claim 18, wherein the rear frame portion of the roll cage is configured to provide stable support for the second orientation in which the battery pack insertion direction is generally vertical.

21. The battery pack charger of claim 20, wherein the battery pack charger includes a coupling plate for coupling the housing to a storage container,
wherein a bottom of the housing of the battery pack charger is configured to removably attached to a top of the coupling plate, and
wherein the bottom of the coupling plate is configured to provide stable support for the first orientation in which the battery pack insertion direction is generally horizontal.
